(19) United States
(12) Patent Application Publication
(10) Pub. No.: US 2011/0279852 A1
(43) Pub. Date: Nov. 17, 2011

(54) IMAGE PROCESSING APPARATUS, IMAGE PROCESSING METHOD, AND IMAGE PROCESSING PROGRAM

(75) Inventors: Yasumasa ODA, Nagano (JP); Hirohito Kondo, Nagano (JP); Daisuke Kurosaki, Nagano (JP)

(73) Assignee: Sony Corporation, Tokyo (JP)

(21) Appl. No.: 13/082,855

(22) Filed: Apr. 8, 2011

(30) Foreign Application Priority Data
May 12, 2010 (JP) 2010-110419

(51) Int. Cl. G06F 3/12

(52) U.S. Cl. 358/1.15

(57) ABSTRACT

An image processing apparatus having a display unit includes: an operation section configured to generate an operation signal based on a user's contact with the display unit; a posting area display control section configured to display a posting area in which an image is posted on the display unit and displaying previously-generated images in the posting area; an operation detail recognizing section configured to recognize an operation detail on the images posted in the posting area on the basis of the operation signal from the operation section; and a selection section configured to select an image corresponding to the operation detail recognized by the operation detail recognizing section as an operation object.

### BACKGROUND OF THE TECHNOLOGY

1. Field of the Technology

The present technology relates to an image processing apparatus, an image processing method, and an image processing program, and more particularly, to an image processing apparatus, an image processing method, and an image processing program, which can easily enable operating a large quantity of image messages including captured still images or moving images.

2. Description of the Related Art

Techniques of transmitting an e-mail with an image message including a still image or a moving image have been widely spread.

When it is intended to attach a still image or a moving image as an image message to an e-mail and to transmit the resultant e-mail, a user first operates a keyboard or operation buttons of an electronic apparatus such as a personal computer to input a destination, a subject, and a text and to prepare an e-mail. Then, the user operates the keyboard or the operation buttons to select an image which it is desired to attach and transmit. The user operates the keyboard or the operation buttons to perform an operation of attaching the selected image message to the prepared e-mail and then to perform an operation of transmitting the e-mail.

At this time, in order to select an image, a technique of displaying plural still images captured in advance as a list of thumbnail images and displaying the selected image by selecting a desired thumbnail image has been proposed (see JP-A-2008-146453).

The user selects an image message to be attached by the use of this technique, performs an operation of attaching the selected image message to an e-mail, and then transmits the e-mail.

A technique of inputting various commands by touching the surface of a display unit to correspond to display information as processing results of an electronic apparatus by the use of a so-called touch panel in which a display unit and an operation input unit of the electronic apparatus are unified has been known. The above-mentioned list of thumbnail images can be displayed on the touch panel and an image can be selected by touching a part where a desired thumbnail image is displayed. For example, Touch Pack (trademark) has been proposed as software using a touch panel (http://japanese.engadget.com/2009/05/28/windows-7-and-microsoft-touch-pack/).

### SUMMARY OF THE TECHNOLOGY

In recent years, electronic apparatuses having an image-capturing camera function have multiplied and opportunities for users to directly capture an image with the electronic apparatuses and to transmit e-mails with the captured image attached as an image message thereto has multiplied. Accordingly, image messages are used more and more and the management of arranging or erasing a large quantity of image messages is necessary.

However, with the increase in the quantity of the image messages, since the image messages should be selected one by one and the treatment thereof should be determined in order to manage the image messages, it is not possible to perform an operation of efficiently selecting and arranging a large quantity of image messages with a small number of operations.

Thus, it is desirable to efficiently and easily select and process a large quantity of image messages with a small number of operations and to easily perform a desired operation.

According to an embodiment of the present technology, there is provided an image processing apparatus having a display unit, including: an operation section configured to generate an operation signal based on a user's contact with the display unit; a posting area display control section configured to display a posting area in which an image is posted on the display unit and displaying previously-generated images in the posting area; an operation detail recognizing section configured to recognize an operation detail on the images posted in the posting area on the basis of the operation signal from the operation section; and a selection section configured to select an image corresponding to the operation detail recognized by the operation detail recognizing section as an operation object.

The operation detail recognizing section may recognize that the operation detail is an operation of coming into contact with a broad area including a certain image amongst the images when a contact area in which the user comes into contact with the display unit and which includes the certain image amongst the images posted in the posting area is broader than a predetermined area in the posting area on the basis of the operation signal from the operation section. The selection section may select the image existing in a coverage defined by the contact area in the posting area recognized by the operation detail recognizing section as the operation object.

The selection section may select the images existing in a coverage within a radius corresponding to a parameter indicating the operation detail, which is recognized by the operation detail recognizing section, with the image as the center which the user comes into contact with as the operation object.

The image processing apparatus may further include a holding time measuring section configured to measure a holding time in which the user's contact with the predetermined image posted in the posting area is held on the basis of the operation signal from the operation section. In this case, the parameter indicating the operation detail may be the holding time in which the user's contact with the image posted in the posting area and which is measured by the holding time measuring section is held and the operation detail recognizing section may recognize that the operation detail is an operation of holding the contact with the image when the holding time measured by the holding time measuring section is longer than a predetermined time. The selection section may select the image existing in the coverage within a radius corresponding to the holding time with the image as the center on which the operation, which is recognized by the operation detail recognizing section, of holding the contact with the image is performed as the operation object.

The image processing apparatus may further include: a pressure measuring section configured to measure a pressure of the user's contact with an image posted in the posting area on the basis of the operation signal from the operation section; and a hierarchical level managing section configured to manage hierarchical levels of the images in the posting area in the depth direction. In this case, the parameter indicating the operation detail may be the pressure, which is measured by the pressure measuring section, of the user's contact with a predetermined image posted in the posting area and the operation detail recognizing section may recognize that the operation detail is an operation of coming into contact with the image with a high pressure when the pressure, which is measured by the pressure measuring section, of the user's contact with the image posted in the posting area is greater than a predetermined pressure. The selection section may select the images existing in the coverage within a radius corresponding to the pressure with the image as the center on which the operation, which is recognized by the operation detail recognizing section, of coming contact with the image with a high pressure is performed as the operation object.

The posting area display control section may collectively display the images existing in the coverage within a radius corresponding to the parameter indicating the operation detail recognized by the operation detail recognizing section with the image as the center and selected as the operation object by the selection section at the position of the image as the center.

The selection section may select the images existing within a hierarchical level corresponding to the parameter indicating the operation detail recognized by the operation detail recognizing section from the hierarchical level of the image which the user comes into contact with as the operation object.

The image processing apparatus may further include: a holding time measuring section configured to measure a holding time in which the user's contact with a predetermined image posted in the posting area is held on the basis of the operation signal from the operation section; and a hierarchical level managing section configured to manage hierarchical levels of the images in the posting area in the depth direction. In this case, the parameter indicating the operation detail may be the holding time, which is measured by the holding time measuring section, of the user's contact with a predetermined image posted in the posting area and the operation detail recognizing section may recognize that the operation detail is an operation of holding the contact with a predetermined image when the holding time measured by the holding time measuring section is longer than a predetermined time. The selection section may select the images existing from the hierarchical level, which is the highest hierarchial level, of the image on which the operation of holding the contact with the predetermined image is performed to the hierarchical level set to correspond to the holding time among the images contacting the predetermined image on which the operation of holding the contact with the predetermined image is performed as the operation object on the basis of the image on which the operation, which is recognized by the operation detail recognizing section, of holding the contact with the predetermined image is performed and the hierarchical levels, which are managed by the hierarchical level managing section, of the images contacting the predetermined image.

The image processing apparatus may further include: a pressure measuring section configured to measure a pressure of the user's contact with an image posted in the posting area on the basis of the operation signal from the operation section; and a hierarchical level managing section configured to manage hierarchical levels of the images in the posting area in the depth direction. In this case, the parameter indicating the operation detail may be the pressure, which is measured by the pressure measuring section, of the user's contact with a predetermined image posted in the posting area and the operation detail recognizing section may recognize that the operation detail is an operation of coming into contact with the predetermined image with a high pressure when the pressure, which is measured by the pressure measuring section, of the user's contact with the predetermined image posted in the posting area is greater than a predetermined pressure. The selection section may select the existing images from the hierarchical level, which is the highest hierarchial level, of the image on which the operation of coming into contact with the predetermined image with a high pressure is performed to the hierarchical level set to correspond to the pressure among the images contacting the image on which the operation of coming into contact with the predetermined image with a high pressure is performed as the operation object on the basis of the predetermined image on which the operation, which is recognized by the operation detail recognizing section, of coming into contact with the predetermined image with a high pressure is performed and the hierarchical levels, which are managed by the hierarchical level managing section, of the images contacting the predetermined image.

The posting area display control section may collectively display the images existing within the hierarchical level corresponding to the parameter indicating the operation detail recognized by the operation detail recognizing section and selected as the operation object by the selection section at the position of the image as the center.

The operation detail recognizing section may recognize that the operation detail is an operation of coming into contact with an area not including any image when the contact area is an area not including any image in the posting area on the basis of the operation signal from the operation section. In this case, the selection section may select all the images as the operation object on the basis of the operation detail recognized by the operation detail recognizing section, and the posting area display control section may arrange and display all the images posted in the posting area.

The posting area display control section may acquire the current positions of all the selected images and destination positions after the arrangement and displays all the images posted in the posting area at positions moved only by a predetermined distance among the distances from the current positions to the destination positions.

According to another embodiment of the present technology, there is provided an image processing method in an image processing apparatus having a display unit, an operation section configured to generate an operation signal based on a user's contact with the display unit, a posting area display control section configured to display a posting area in which an image is posted on the display unit and displaying previously-generated images in the posting area, an operation detail recognizing section configured to recognize an operation detail on the images posted in the posting area on the basis of the operation signal from the operation section, and a selection section configured to select an image corresponding to the operation detail recognized by the operation detail recognizing section as an operation object. The image processing method includes the steps of: causing the operation section to generate the operation signal based on the user's contact with the display unit; causing the posting area display control section to display the posting area in which an image is posted on the display unit and to display the previously-generated images in the posting area; causing the operation detail recognizing section to recognize the operation detail on the images posted in the posting area on the basis of the operation signal generated in the step of generating the operation signal; and causing the selection section to select an image corresponding to the operation detail recognized in the step of recognizing the operation detail as the operation object.

According to still another embodiment of the present technology, there is provided a program allowing a computer to control an image processing apparatus having a display unit, an operation section configured to generate an operation signal based on a user's contact with the display unit, a posting area display control section configured to display a posting area in which an image is posted on the display unit and displaying previously-generated images in the posting area, an operation detail recognizing section configured to recognize an operation detail on the images posted in the posting area on the basis of the operation signal from the operation section, and a selection section configured to select an image corresponding to the operation detail recognized by the operation detail recognizing section as an operation object. The program causes the computer to perform an image processing method including the steps of: causing the operation section to generate the operation signal based on the user's contact with the display unit; causing the posting area display control section to display the posting area in which an image is posted on the display unit and to display the previously-generated images in the posting area; causing the operation detail recognizing section to recognize the operation detail on the images posted in the posting area on the basis of the operation signal generated in the step of generating the operation signal; and causing the selection section to select an image corresponding to the operation detail recognized in the step of recognizing the operation detail as the operation object.

According to the embodiments of the present technology, the operation signal based on the user's contact with the display unit is generated, the posting area in which an image is posted is displayed on the display unit, the previously-generated images are displayed in the posting area, the operation detail on the image posted in the posting area is recognized on the basis of the operation signal, and the image corresponding to the recognized operation detail is selected as the operation object.

The image processing apparatus according to the embodiment of the present technology may be an independent apparatus or may be a block processing an image.

According to the above-mentioned embodiments, it is possible to efficiently and easily select and process a large quantity of image messages with a small number of operations and to easily perform a desired operation.

### BRIEF DESCRIPTION OF THE DRAWINGS

FIG. 1 is a diagram illustrating the configuration of an image processing apparatus according to an embodiment of the present technology.

FIG. 2 is a diagram illustrating the configurational example of functions performed by the image processing apparatus shown in FIG. 1.

FIG. 3 is a flow diagram illustrating the flow of a message managing procedure.

FIG. 4 is a diagram illustrating a display example of a main board.

FIG. 5 is a flow diagram illustrating the flow of a setting procedure.

FIG. 6 is a diagram illustrating a setting window.

FIG. 7 is a flow diagram illustrating the flow of a new message preparing procedure.

FIG. 8 is a diagram illustrating the new message preparing process.

FIG. 9 is a flow diagram illustrating the flow of an editing procedure.

FIG. 10 is a diagram illustrating the editing procedure.

FIG. 11 is a diagram illustrating the editing procedure.

FIG. 12 is a flow diagram illustrating the flow of a message display operating procedure.

FIG. 13 is a flow diagram illustrating the flow of the message display operating procedure.

FIG. 14 is a flow diagram illustrating the flow of the message display operating procedure.

FIG. 15 is a flow diagram illustrating the flow of the message display operating procedure.

FIG. 16 is a diagram illustrating the message display operating procedure.

FIG. 17 is a diagram illustrating the message display operating procedure.

FIG. 18 is a diagram illustrating the message display operating procedure.

FIG. 19 is a diagram illustrating the message display operating procedure.

FIG. 20 is a flow diagram illustrating the flow of a message reproducing procedure.

FIG. 21 is a diagram illustrating the message reproducing procedure.

FIG. 22 is a diagram illustrating a message transmitting procedure.

FIGS. 23A and 23B show a flow diagram illustrating the message transmitting procedure.

FIG. 24 is a diagram illustrating a message transmitting procedure of transmitting plural image messages.

FIG. 25 is a diagram illustrating a wastebasket managing procedure.

FIG. 26 is a flow diagram illustrating the wastebasket managing procedure.

### DESCRIPTION OF THE PREFERRED EMBODIMENTS

### Configuration of Image Processing Apparatus

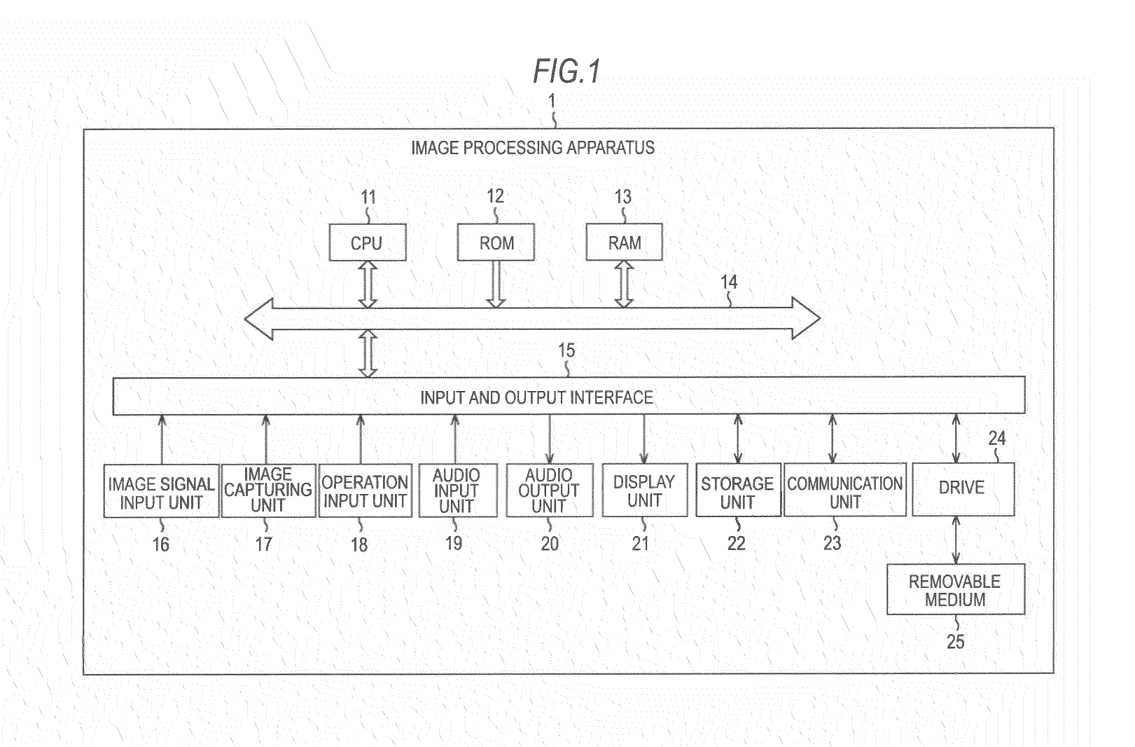

FIG. 1 is a diagram illustrating the hardware configuration of an image processing apparatus according to an embodiment of the present technology. An image processing apparatus 1 shown in FIG. 1 includes a touch panel and generates an image message on the basis of an image captured in real time. The image processing apparatus 1 transmits an e-mail with the generated image message attached thereto. That is, the image processing apparatus 1 is, for example, a personal computer including a display unit employing a touch panel in which the display unit and a main body are unified. The image message described herein includes a still image message and a moving image message including only a still image and a moving image and an edited still image message and an edited moving image message having been subjected to an editing process using text, illustration, effects, and the like. Hereinafter, when the still image message, the moving image message, the edited still image message, and the edited moving image message need not be particularly distinguished from each other, these are simply referred to as an image message. When the execution of the editing process need not be particularly mentioned, the edited still image message and the still image message are both simply referred to as a still image message. When the edited moving image message and the moving image message need not be particularly distinguished from each other, both are simply referred to as a moving image message.

The image processing apparatus 1 includes a CPU (Central Processing Unit) 11, a ROM (Read Only Memory) 12, a RAM (Random Access Memory) 13, a bus 14, an input and output interface 15, an image signal input unit 16, an image capturing unit 17, an operation input unit 18, and an audio input unit 19. The image processing apparatus 1 further includes an audio output unit 20, a display unit 21, a storage unit 22, a communication unit 23, and a drive 24.

The CPU 11 controls the entire behavior of the image processing apparatus 1 and performs various processes by properly developing programs stored in the ROM 12 or the storage unit 22 into the RAM 13. The CPU 11 executes various programs on the basis of signals input from various elements connected thereto via the bus 14 and the input and output interface 15 and outputs the processing results from various elements via the bus 14 and the input and output interface 15.

The image signal input unit 16 receives various image signals based on the NTSC (National Television Standards Committee) standard or the HDMI (High-Definition Multimedia Interface) standard and supplies the received image signals to the CPU 11 or the storage unit 22 as needed. The image signal input unit 16 supplies the received image signals to the display unit 21 including an LCD (Liquid Crystal Display) or an organic EL (Electro-Luminescence) display so as to display the image signals.

The image capturing unit 17 includes an image pickup device such as a CCD (Charge Coupled Device) or a CMOS (Complementary Metal Oxide Semiconductor), captures an image, and supplies the captured image to the CPU 11 or the storage unit 22. The image capturing unit 17 supplies the captured image to the display unit 21 including an LCD or an organic EL display so as to display the image.

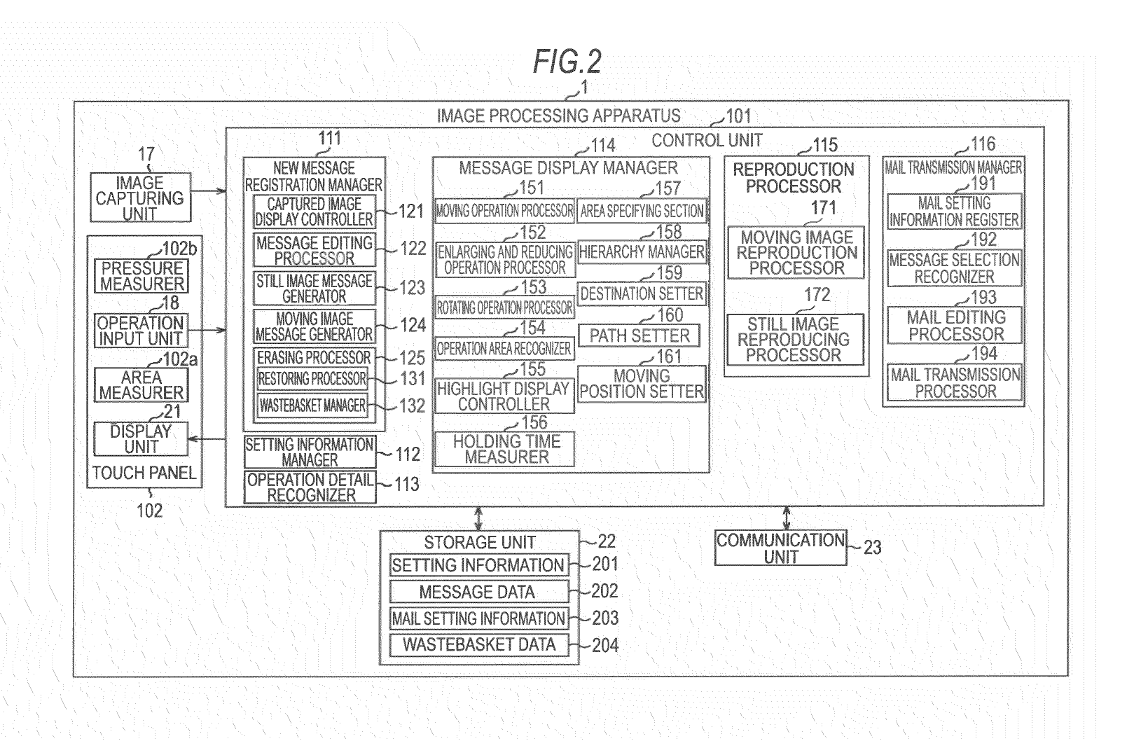

The operation input unit 18 has an input function like a keyboard or a mouse, generates an operation signal based on a user's operation detail, and supplies the generated operation signal to the CPU 11. In this embodiment, the operation input unit 18 and the display unit 21 are unified to form a so-called touch panel 102 (see FIG. 2). That is, the touch panel displays necessary information, displays operation buttons or switches as a user interface to receive an input operation based on the user's contact with display positions of the operation buttons or switches, and generates the operation signal corresponding to the received input operation. The image capturing unit 17 is disposed above the touch panel 102 and captures a side facing the touch panel 102. That is, when the user is located at the position facing the touch panel 102 and operates the touch panel 102, the image capturing unit captures an image of the user in operation.

The audio input unit 20 includes, for example, a microphone, receives an audio input, and outputs the received audio as an audio signal. The display unit 21 includes an LCD or an organic EL display, is controlled by the CPU 11, and displays an image on the basis of the image signal from the image signal input unit 16, the image capturing unit 17, and the storage unit 22.

The storage unit 22 includes, for example, an HDD (Hard Disk Drive) or an SSD (Solid State Drive), is controlled by the CPU 11, stores various programs, setting data, image signals (including still images and moving images), and audio signals, and reads them as needed.

The communication unit 23 includes an Ethernet board or the like, is controlled by the CPU 11, and communicates with other electronic apparatuses via public phone lines or Internet not shown to transmit and receive various data. The data to be transmitted to and received from other electronic apparatuses includes data of e-mails with other electronic apparatuses.

The drive 24 is controlled by the CPU 11 and reads and writes data from and to a removable medium 25 such as a magnetic disk (including a flexible disk), an optical disk (including a CD-ROM (Compact Disc-Read Only Memory) and a DVD (Digital Versatile Disc)), a magneto-optical disk (including an MD (Mini Disc)), or a semiconductor memory.

### [Functional Configuration to be Implemented by Image Processing Apparatus]

The functional configuration to be implemented by hardware of the image processing apparatus 1 shown in FIG. 1 will be described below with reference to the functional block diagram of FIG. 2. The constituent elements in the functional block diagram shown in FIG. 2 are embodied by causing the hardware of the image processing apparatus 1 shown in FIG. 1 to execute various programs, but may be implemented by hardware having the same functions. Therefore, the functional block diagram shown in FIG. 2 may be a functional block diagram embodied by a program or may be a functional block diagram embodied by hardware having the same functions.

The image processing apparatus 1 includes a control unit 101, a touch panel 102, an image capturing unit 17, a storage unit 22, and a communication unit 23. The control unit 101 controls the entire behavior of the image processing apparatus 1, generates an image message to be attached to an e-mail on the basis of an operation signal supplied from the touch panel 102, and transmits the e-mail with the generated image message attached thereto from the communication unit 23.

The control unit 101 includes a new message registration manager 111, a setting information manager 112, an operation detail recognizer 113, a message display manager 114, a reproduction processor 115, and a mail transmission manager 116.

The new message registration manager 111 generates a new image message, registers the generated new image message as message data 202 in the storage unit 22, and manages the message data 202. The new message registration manager 111 includes a captured image display controller 121, a message editing processor 122, a still image message generator 123, a moving image message generator 124, and an erasing processor 125. The captured image display controller 121 controls an image displayed on the display unit 21 on the basis of the image captured by the image capturing unit 17 at the time of generating a new image message.

At the time of editing the image captured as the new image message, the message editing processor 122 edits an image on the basis of the operation signal of the touch panel 102 and registers the edited image as the message data 202.

The still image message generator 123 generates an image message on the basis of a still image captured by the image capturing unit 17, registers the generated image message as the message data 202 in the storage unit 22, and displays the generated image message on the display unit 21. The moving image message generator 124 generates an image message on the basis of a moving image captured by the image capturing unit 17, registers the generated image message as the message data 202 in the storage unit 22, and displays the generated image message on the display unit 21.

The erasing processor 125 manages an erasing or restoring process by inputting the message data 202 stored in the storage unit 22 to a wastebasket to be described later. More specifically, the erasing processor 125 includes a restoring processor 131 and a wastebasket manager 132. When the generated message is input to wastebasket (when it is dragged and dropped to an icon representing the wastebasket), the wastebasket manager 132 considers the generated message as being erased, erases the generated image from the display unit 21, and registers the message as wastebasket data 204 in the storage unit 22. When it is instructed to perform a wastebasket managing procedure, the wastebasket manager 132 reads the wastebasket data 204 from the storage unit and displays a list of erased messages. When it is instructed to erase the wastebasket data through the use of the operation of the operation input unit 18, the wastebasket manager 132 erases the message data registered in the wastebasket data 204 and completely removes the message data. On the other hand, when it is instructed to restore the message, the restoring processor 131 reads and restores the data of the message which it is instructed to restore from the wastebasket data 204 and displays the message data on the display unit 21 in its original state.

The setting information manager 112 registers and manages setting information for setting the type of the image capturing unit 17 used to prepare a new message, the folder in the storage unit 22 storing the message data, and the like in the storage unit 22.

The operation detail recognizer 113 recognizes the operation detail on the basis of the operation signal supplied from the operation input unit 18 of the touch panel 102 and outputs the recognized operation detail. That is, the operation detail recognizer 113 recognizes the operation detail applied to buttons or icons in display on the basis of the correspondence between a position, an area, and a pressure with which the user comes in contact on the display screen of the display unit and the position on the display image. More specifically, the operation detail recognizer 113 recognizes a pressing operation, a dragging operation, or a dropping operation on the buttons or icons on the display unit 21. The operation detail recognizer 113 recognizes that one image message is selected and a broad area including image messages contacting the selected image message is contacted or that an image message is contacted with a pressure equal to or greater than a predetermined pressure. The operation detail recognizer 113 recognizes that an image message is selected and contacted for a predetermined time or longer or that an area in which no image message exists is contacted.

The message display manager 114 displays a message board having a board shape which is set as an area (message board display area) in which image messages are displayed in the display area of the display unit 21 and manages the display state of the image messages displayed in the message board. More specifically, the message display manager 114 manages the display state of the previously-generated image messages on the basis of the message data 202 of the storage unit 22. The message display manager 114 displays an image message newly generated by the new message registration manager 111 in addition to the previously-generated image messages and manages the display state thereof.

More specifically, the message display manager 114 includes a moving operation processor 151, an enlarging and reducing operation processor 152, a rotating operation processor 153, an operation area recognizer 154, a highlight display controller 155, a holding time measurer 156, an area specifying section 157, a hierarchy manager 158, a destination setter 159, a path setter 160, and a moving position setter 161. The moving operation processor 151 moves the display position of an image message on the basis of the operation detail input to the operation input unit 18 and displays the moved image message. The enlarging and reducing operation processor 152 enlarges or reduces the display size of an image message on the basis of the operation detail input to the operation input unit 18 and displays the enlarged or reduced image message. The rotating operation processor 153 rotates the display angle of an image message on the basis of the operation detail input to the operation input unit 18 and displays the rotated image message.

The operation area recognizer 154 recognizes the operation area of the user's contact with the touch panel 102 on the basis of the operation signal. The highlight display controller 155 highlights an image message in a selected area selected as a processing object. When an image message is contacted for a predetermined time or longer, the holding time measurer 156 measures the holding time in which the contact state is held on the basis of the operation detail recognized by the operation detail recognizer 113. The area specifying section 157 sets the selected area of the image message selected as a processing object on the basis of the operation detail recognized by the operation detail recognizer 113.

The hierarchy manager 158 manages hierarchical levels of plural image messages in the depth direction of the board. More specifically, the hierarchy manager 158 manages the hierarchical levels of the image messages with serial numbers given to correspond to the preparation dates and times of the image messages. In default, the hierarchical level of the latest preparation date and time is set to the highest level (first level) and the hierarchical level of the oldest preparation date and time displayed at the very front in the display unit 21 is set to the lowest level. The image message set to the lowest hierarchical level is displayed at the very back (since other image messages are displayed thereon, an image message that is not displayed may exist). The hierarchical manager 158 changes the display order along with the date information and manages the hierarchical levels, when the hierarchical levels are changed by the operation on the image messages. When the operation detail recognizer 113 recognizes that the operation detail is the contact with a position where no image message exists, the destination setter 159 sets the destinations of all the image messages at the time of arranging and displaying all the image messages. When the operation detail recognizer 113 recognizes that the operation detail is the contact with the position where no image message exists, the path setter 160 sets moving paths of all the image messages from the current positions to the destinations set by the destination setter 159. The moving position setter 161 sets the moving position to positions to which all the image messages are moved by predetermined distances from the current position along the moving paths set by the path setter 160 and moves all the image messages.

The reproduction processor 115 reproduces the image message including a still image and the image message including a moving image among the image messages on the basis of the operation detail input to the operation input unit 18.

The mail transmission manager 116 transmits an e-mail with an image message attached thereto on the basis of the operation detail input to the operation input unit 18. More specifically, the mail transmission manager 116 includes a mail setting information register 191, a message selection recognizer 192, a mail editing processor 193, and a mail transmission processor 194. The mail setting information register 191 registers the setting information of an e-mail to which an image message is attached as mail setting information 203 in the storage unit 22. The mail setting information includes information of a destination address, a subject, and a text and is managed in the storage unit 22 in terms of the profile name. The message selection recognizer 192 recognizes an image message selected on the basis of the operation detail of the operation input unit 18. The mail editing processor 193 edits the information of the destination address, the subject, and the text included in the mail setting information on the basis of the operation detail of the operation input unit 18. When it is instructed to transmit an e-mail in accordance with the operation detail of the operation input unit 18, the mail transmission processor 194 controls the communication unit 23 to transmit an e-mail with the selected image message attached thereto on the basis of the mail setting information.

The touch panel 102 includes an operation input unit 18, a display unit 21, an area measurer 102a, and a pressure measurer 102b. The area measurer 102a measures a contact area when the touch panel 102 is operated by a user. The pressure measurer 102b measures the pressure when the display unit 21 is pressed by the user. The operation input unit 18 supplies an operation signal to the control unit 101 along with information of the pressure measurement result and the area measurement result.

### [Message Managing Procedure]

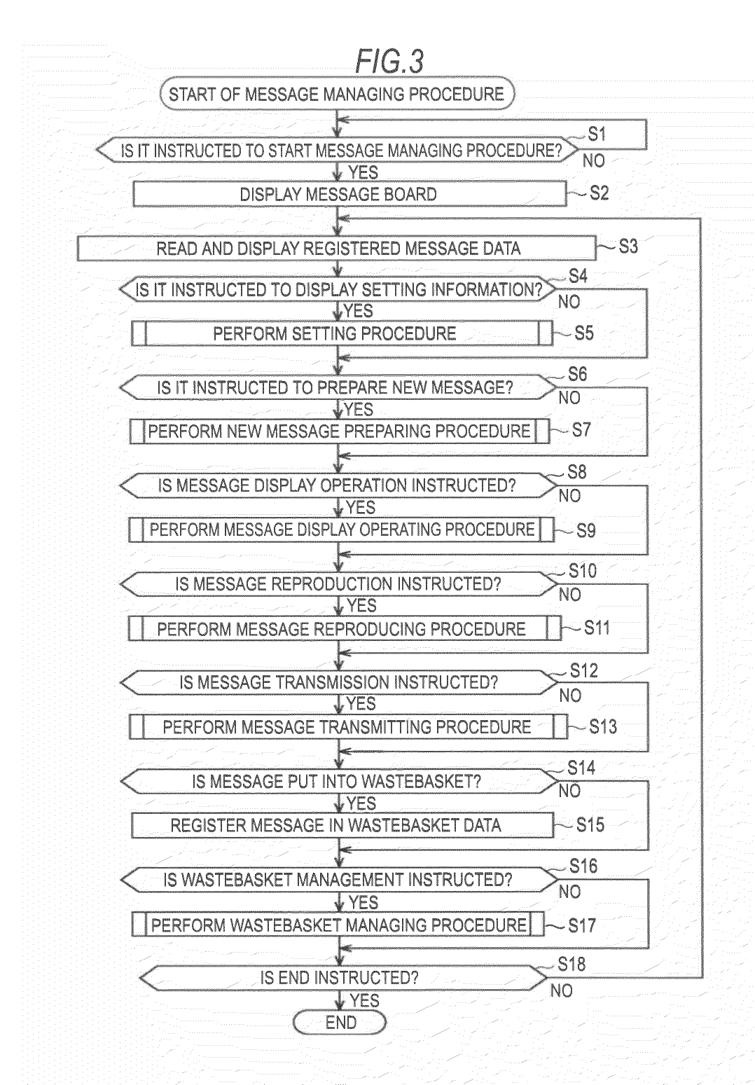

A message managing procedure will be described below with reference to the flow diagram shown in FIG. 3.

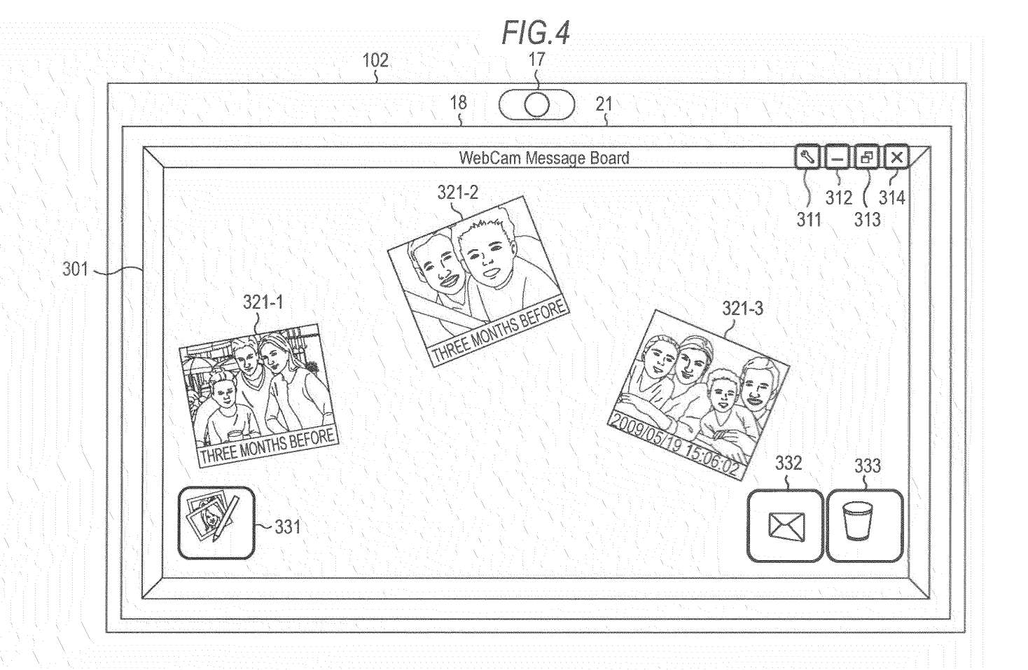

In step S1, the message display manager 114 determines whether it is instructed to start the message managing procedure from the operation detail recognizer 113, and repeats the same process until it is instructed to start the message managing procedure. When it is determined in step S1 that an operation button (not shown), which is displayed on the touch panel 102, for instructing to start the message managing procedure is operated by the user, the operation input unit 18 generates a corresponding operation signal and supplies the generated operation signal to the control unit 101 in step S2. At this time, when it is recognized on the basis of the operation signal that it is instructed to start the message managing procedure, the operation detail recognizer 113 notifies the recognition result to the message display manager 114. In response to the notification representing that the operation of instructing to start the message managing procedure is recognized from the operation detail recognizer 113, the message display manager 114 displays a message board 301, for example, as shown in FIG. 4.

FIG. 4 shows a state where the touch panel 102 displays the message board 301. The touch panel 102 includes the image capturing unit 17 above the frame part thereof. Accordingly, the image capturing unit 17 captures an image of an area facing the surface of the operation input unit 18 and the display unit 21 (a unified member in the drawing). As a result, the image capturing unit 17 actually captures an image of the user operating or viewing the touch panel 102 of the image processing apparatus 1.

In step S3, the message display manager 114 reads the message data 202 stored in the storage unit 22 and displays image messages 321-1 to 321-3 in a main board 301, for example, as shown in FIG. 4.

In FIG. 4, an image in which three family members appear is displayed in the image message 321-1 and “three months before” is described on the lower-right side, which represents that the image message including the image in which three family members appear was generated three months before. The description “three months before” on the lower side is displayed by the message display manager 114 on the basis of the date and time at which the image message 321-1 was generated.

An image in which a parent and a child appear is displayed in the image message 321-2 and “three months before” is described on the lower-right side, which represents that the image message including the image in which a parent and a child appear was generated three months before. An image in which four family members appear is displayed in the image message 321-3 and “2009/5/19 15:06:02” is described on the lower-right side. That is, it is shown that the image message 321-3 including the image in which four family members appear was generated at 15:06:02 of May 19, 2009.

Hereinafter, when the image messages 321-1 to 321-3 need not be particularly distinguished from each other, they are simply referred to as an image message 321 and the same is true of the other configurations. As described later, in case of an image message including moving image data, the message display manager 114 further displays a play button having a triangular shape convex to the right in the vicinity of the center of the image message 321. By providing such a difference in display, it is possible to distinguish the image message 321 as either still image data or moving image data at a glance.

Buttons 311 to 314 are displayed from the left on the upper-right side of the message board 301. The button 311 is a button that is pressed to display the setting information. The button 312 is a button that is pressed to minimize the message board 301. The button 313 is a button that is pressed to maximize the message board 301 or to return the message board to the original size. The button 314 is a button that is pressed to end the message board. The buttons 311 to 314 are recognized as being pressed, as described above, when the user's fingertip comes into contact with the areas in which the buttons 311 to 314 are displayed on the display unit 21 of the touch panel 102. In this embodiment, the other buttons can be pressed by the same operation.

An icon 331 instructing to generate a new message, an icon 332 instructing to transmit an e-mail with an image message attached thereto, and an icon 333 instructing to input an image message to a wastebasket are displayed on the message board 301.

The icon 331 is pressed by the use of a pointer not shown when the user wants to prepare a new image message. When the user wants to transmit an e-mail with a selected image message attached thereto, the image message selected by the user is dropped onto the icon 332. That is, in the example shown in FIG. 4, when one of the image messages 321-1 to 321-3 is dragged and dropped onto the icon 332, it is instructed to transmit an e-mail with the dropped image message 321 attached thereto.

When the user wants to input a selected message to the wastebasket, the image message 321 selected by the user is dropped onto the icon 333. That is, in the example shown in FIG. 4, when one of the image messages 321-1 to 321-3 is dragged and dropped onto the icon 333, it is instructed to input the dropped image message 321 to the wastebasket.

Here, the “drag” is an operation of selecting and moving one of the image messages 321 in the display area of the display unit 21 and the “drop” is an operation of releasing the selected state of the image message 321 to end the movement and to place the image message at the moving position in the display area.

In this way, by displaying the message board 301, the image message 321 can be displayed as if an actual board were disposed and photographs were attached thereto. The position, the size, and the rotation angle of the image message 321 on the message board 301 are randomly set and displayed by the message display manager 114. In FIG. 4, since the number of image messages 321 is only three, a margin exists on the message board 301 even when all the image messages are displayed. However, when more image messages 321 are displayed, they may overlap with each other. In this case, the message display manager 114 displays new image messages in front of old image messages on the basis of the information on the date and time at which the image message 321 is generated. That is, the newest image message is displayed at the very front and the oldest image message is displayed at the very back. Accordingly, it is possible to express the sensation of an actual board.

The procedure will be described with reference to FIG. 3 again.

In step S4, the setting information manager 112 determines whether it is instructed to display the setting information by the use of the operation detail recognizer 113. That is, it is determined whether the button 311 on the message board 301 displayed on the display unit 21 of the touch panel 102 is operated by the operation input unit 18 and it is instructed to display the setting information.

In step S4, for example, when the operation button 311 is operated to instruct to display the setting information, the setting information manager 112 performs a setting procedure in step S5.

### [Setting Procedure]

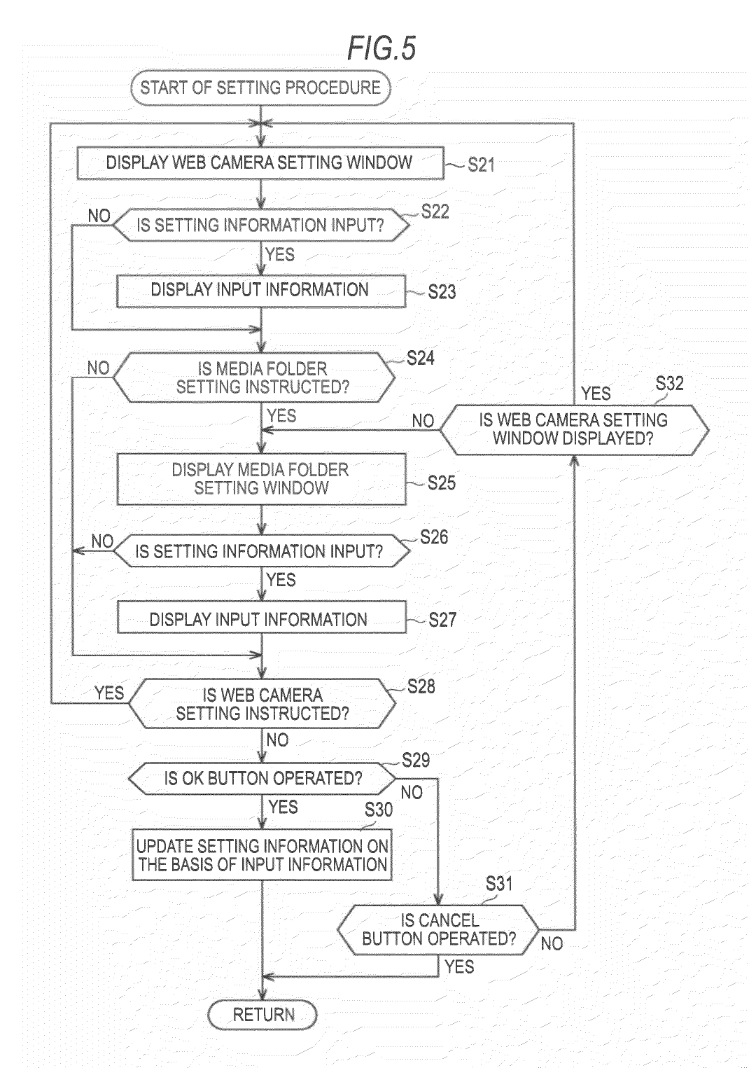

The setting procedure will be described below with reference to the flow diagram shown in FIG. 5.

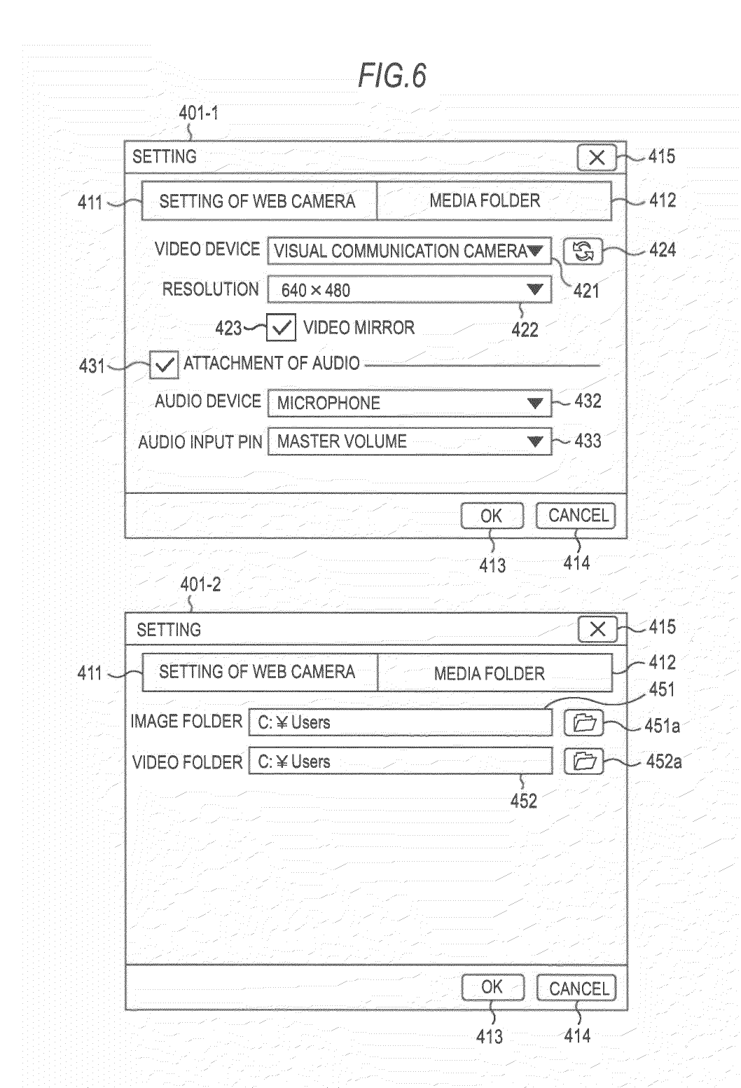

In step S21, the setting information manager 112 displays a web camera setting window 401-1 as the setting information, for example, as shown in the upper stage of FIG. 6. A tab 411 that is operated to be switched to a web camera setting picture and a tab 412 that is operated to be switched to a media folder setting picture are displayed in the upper stage of the web camera setting window 401-1 shown in FIG. 6. A button 413 that is operated at the time of finishing the input of the setting information and that is marked by “OK”, a button 414 that is operated to cancel the input of the setting information and that is marked by “cancel”, and a button 415 that is operated to end the input of the setting information are also displayed.

A video device setting line 421, a resolution setting line 422, a check box 423 for setting a mirror display of a video, and an update button 424 representing the update of the setting state are displayed from the upside below the tabs 411 and 412. When the right button of the video device setting line 421 is pressed, selectable video devices are displayed as a drop-down list for selection. A check box 431 for setting an image message with an audio attached to, an audio device setting line 432, and an audio input pin setting line 433 are displayed below.

In FIG. 6, “Visual Communication Camera” is selected as the video device. When the right button of the resolution setting line 422 is pressed, selectable resolutions are displayed as a drop-down list for selection. In FIG. 6, the resolution of 640×480 pixels is selected. “Video Mirror” is displayed and a check mark is input to the check box 423 when an image captured by the image capturing unit 17 is displayed as a specular image. That is, as described above, the image capturing unit 17 is disposed above the touch panel 102 and captures an image of the facing side. Accordingly, when a user faces the touch panel 102 and the image captured by the image capturing unit 17 is displayed on the display unit 21 of the touch panel 102, the displayed user image is not specular on the actual user side. Then, many users may feel uncomfortable with their images displayed on the touch panel 102. That is, persons often view their images reflected in the mirror. Accordingly, when they view their non-specular images, it is difficult to image the variation in the image of their motions, thereby causing an uncomfortable feeling about the lateral motions. Therefore, when the check box 423 is checked, the display laterally inverts and displays the image captured by the image capturing unit 17. As a result, since a user views the specular image, the user does not have an uncomfortable feeling and can thus edit his or her own image in an editing procedure to be described later.

The check mark is input to the check box 431 when an audio is attached to the image message. At this time, the audio device setting line 432 and the audio input pin setting line 433 are in the operable state. When the right button of the audio device setting line 432 is pressed, selectable audio devices are displayed as a drop-down list for selection. In FIG. 6, “Microphone” is selected as the audio device. When the right button of the audio input pin setting line 433 is pressed, selectable audio input pins are displayed as a drop-down list for selection. In FIG. 6, “Master Volume” is displayed, which represents that an audio is input with the master volume of the image processing apparatus 1.

In step S22, the setting information manager 112 determines whether the operation input unit 18 of the touch panel 102 is operated to input the setting information for setting a web camera on the basis of the operation detail recognized by the operation detail recognizer 113. When it is determined in step S22 that the setting information for setting the web camera is input, the setting information manager 112 displays the setting information reflecting the input setting information on the display unit 21 of the touch panel 102 in step S23. On the other hand, when the setting information for setting the web camera is not input, the process of step S23 is skipped.

In step S24, the setting information manager 112 determines whether the tab 412 is operated to instruct to set a media folder. When it is determined in step S24 that the tab 412 is operated to instruct to set the media folder, the setting information manager 112 displays a media folder setting window 401-2 on the display unit 21, for example, as shown in the lower stage of FIG. 6, in step S25.

From the upside, an image folder setting line 451 and a video folder setting line 452 are disposed in the media folder setting window 401-2, and a line for setting a folder in the storage unit 22 in which image messages including still images and moving images are registered is also disposed therein. Reference buttons 451a and 452a are disposed on the right sides of the image folder setting line 451 and the video folder setting line 452. The reference buttons 451a and 452a are buttons that are pressed to refer to selectable folders and the selectable folders are displayed for selection by operating the reference buttons 451a and 452a. In FIG. 6, “C:¥Users” is selected, which represents that the image message is registered in the folder specified by “¥Users” in C drive.

In step S26, the setting information manager 112 determines whether the operation input unit 18 of the touch panel 102 is operated to input the setting information for setting a media folder on the basis of the operation detail recognized by the operation detail recognizer 113. When it is determined in step S26 that the setting information for setting a media folder is input, the setting information manager 112 displays the setting information reflecting the input setting information on the display unit 21 of the touch panel 102 in step S27. On the other hand, when the setting information for setting a media folder is not input, the process of step S27 is skipped.

When it is determined in step S24 that it is not instructed to set a media folder, the processes of steps S25 to S27 are skipped.

In step S28, the setting information manager 112 determines whether the tab 411 is pressed to instruct to set the web camera again. For example, when the tab 411 is pressed to instruct to set the web camera, the procedure is returned to step S21. On the other hand, when it is determined in step S28 that the tab 411 is not pressed and it is thus not instructed to set the web camera, the setting information manager 112 determines whether the button 413 is pressed to instruct OK, that is, to end the setting with the set details, in step S29. When it is determined in step S29 that the button 413 is operated, the procedure goes to step S30.

In step S30, the setting information manager 112 updates the setting information 201 on the basis of the setting details of the web camera setting window 401-1 and the media folder setting window 401-2, stores the updated setting information in the storage unit 22, and ends the setting procedure.

On the other hand, when it is determined in step S29 that the button 413 is not pressed and it is thus not instructed to end the setting procedure, the setting information manager 112 determines whether button 414 is pressed to instruct to cancel the setting procedure in step S31.

For example, when it is determined in step S31 that the button 414 is pressed to instruct to cancel the setting procedure, the procedure is ended. That is, the setting information manager 112 ends the setting procedure without updating the setting information 201 regardless of the setting details of the web camera setting window 401-1 and the media folder setting window 401-2. In step S31, the process regarding the pressing of the button 415 that is pressed to instruct to end the procedure is the same as the case of the button 414.

When it is determined in step S31 that the button 414 is not pressed, the setting information manager 112 determines whether the web camera setting window 401-1 is currently displayed in step S32. When it is determined in step S32 that the web camera setting window 401-1 is displayed, the procedure is returned to step S21. When the web camera setting window 401-1 is not displayed, the procedure is returned to step S25. That is, as long as the buttons 413 to 415 are not operated, the processes of steps S21 to S29 and steps S31 and S32 are repeated, and the state where the setting information is displayed but the setting can be changed is maintained. When the button 413 is pressed, the setting information 201 is updated to reflect the setting state at that time, is stored in the storage unit 22, and the setting procedure is then ended. When the buttons 414 and 415 are pressed, the setting information 201 is not updated and the setting procedure is ended.

By the above-mentioned processes, the setting information of generating an image message is updated and registered.

The procedure will be described with reference to FIG. 3 again.

The setting procedure is ended in step S5, the procedure goes to step S6. When it is determined in step S4 that it is not instructed to display the setting information, the process of step S5 is skipped.

In step S6, the new message registration manager 111 determines whether it is instructed to prepare a new message on the basis of the recognition result of the operation detail of the operation input unit 18 of the touch panel 102 by the operation detail recognizer 113. For example, when it is determined in step S6 that the icon 331 shown in FIG. 4 is pressed by a pointer not shown to instruct to prepare a new message, the procedure goes to step S7.

In step S7, the new message registration manager 111 performs a message preparing procedure, and prepares and registers a new message in the message data 202 of the storage unit 22.

### [New Message Preparing Procedure]

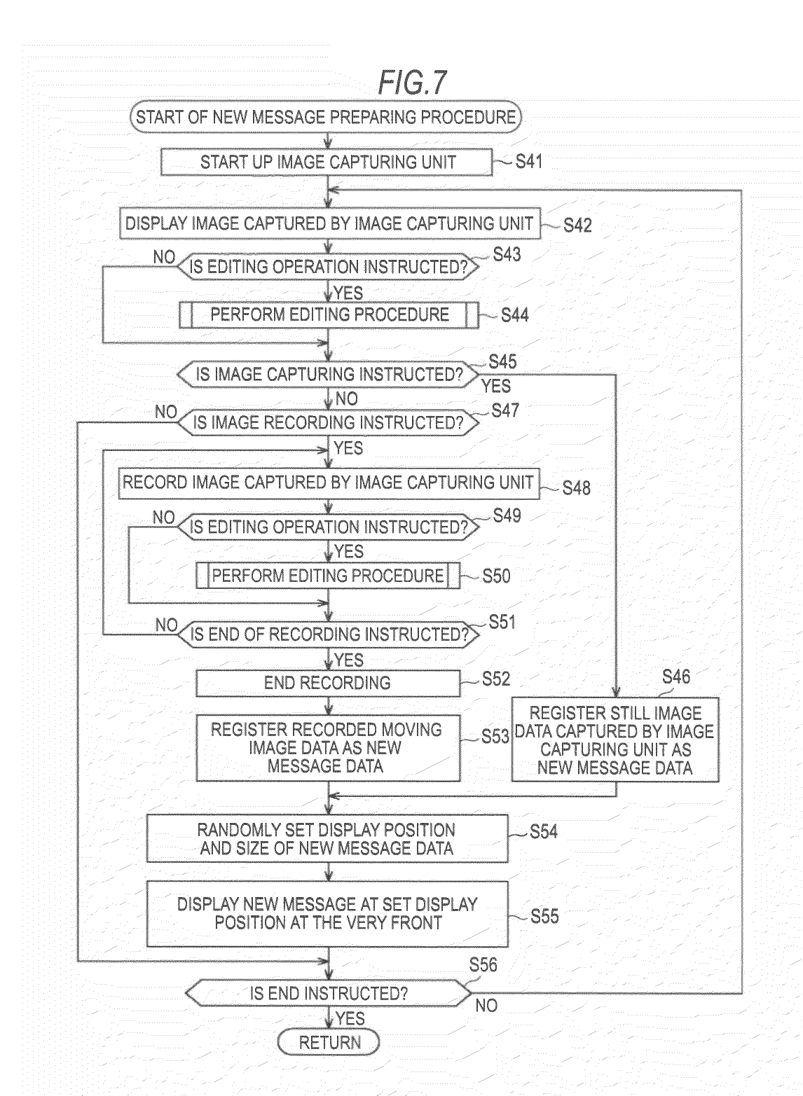

The new message preparing procedure will be described below with reference to the flow diagram shown in FIG. 7.

In step S41, the captured image display controller 121 starts up the image capturing unit 17 and starts the capturing of an image. Accordingly, the image capturing unit 17 starts the capturing of an image and supplies the image captured through the use of an optical system not shown as image data to the control unit 101.

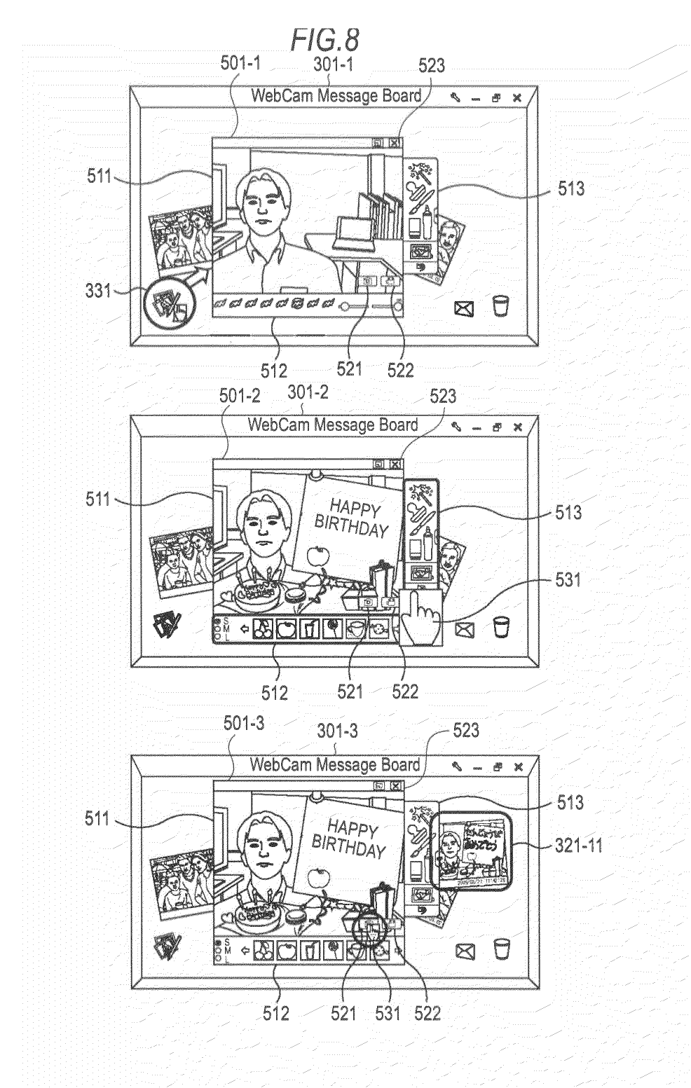

In step S42, the captured image display controller 121 acquires the image captured by the image capturing unit 17 and displays the captured image in a window 501-1 on the display unit 21 of the touch panel 102, for example, as shown in the uppermost stage of FIG. 8. A captured image display line 511, an editing tray display line 512, and an editing tool display line 513 are disposed in the window 501-1. The captured image display line 511 displays the image data supplied from the image capturing unit 17 in real time. The captured image display line 511 is provided with a button 521 that is operated to instruct capture an image, a button 522 that is operated to instruct to start and end the recording of a moving image, and a button 523 that is operated to close the window.

A person's upper body captured by the image capturing unit 17 is displayed in the captured image display line 511 shown in FIG. 8. In FIG. 8, a message board 301-1 in which the captured image display line 511 not subjected to an editing procedure to be described later is displayed, a message board 301-2 having been subjected to the editing procedure, and a message board 301-3 having been subjected to a capturing procedure are displayed from the upside.

In the editing tray display line 512, trays are changed and displayed depending on the editing tools. Examples of the editing tools include an animation editing tool, a stamp editing tool, a watercolor pen editing tool, an eraser editing tool, a pen editing tool, and a frame editing (frame switching) tool. A tray corresponding to the watercolor pen editing tool is displayed in the editing tray display line 512 in the uppermost stage of FIG. 8.

Icon images indicating the types of editing which can be selected as editing tools are displayed in the editing tool display line 513 and the editing details are switched by selecting the icon images. In the example shown in FIG. 8, a stared-stick icon for selecting the animation editing mode, a stamp-like icon for selecting the stamp editing mode, a brush-like icon for selecting the watercolor pen editing mode, and an eraser-like icon for selecting the eraser editing mode are displayed. In addition, a pen-like icon for selecting a pen editing and a frame-like icon for selecting a frame editing are displayed. The editing tool is selected depending on the selected icon and the tray displayed in the editing tray display line 512 is switched and displayed depending on the selected editing tool.

In step S43, the message editing processor 122 determines whether the operation input unit 18 of the touch panel 102 is operated to instruct to perform an editing operation by the use of the operation detail recognizer 113. That is, when the editing tool display line 513 or the editing tray display line 512 displayed on the display unit 21 of the touch panel 102 is operated by the operation input unit 18 so as to instruct the editing, the procedure goes to step S44 and the editing procedure is performed.

### [Editing Procedure]

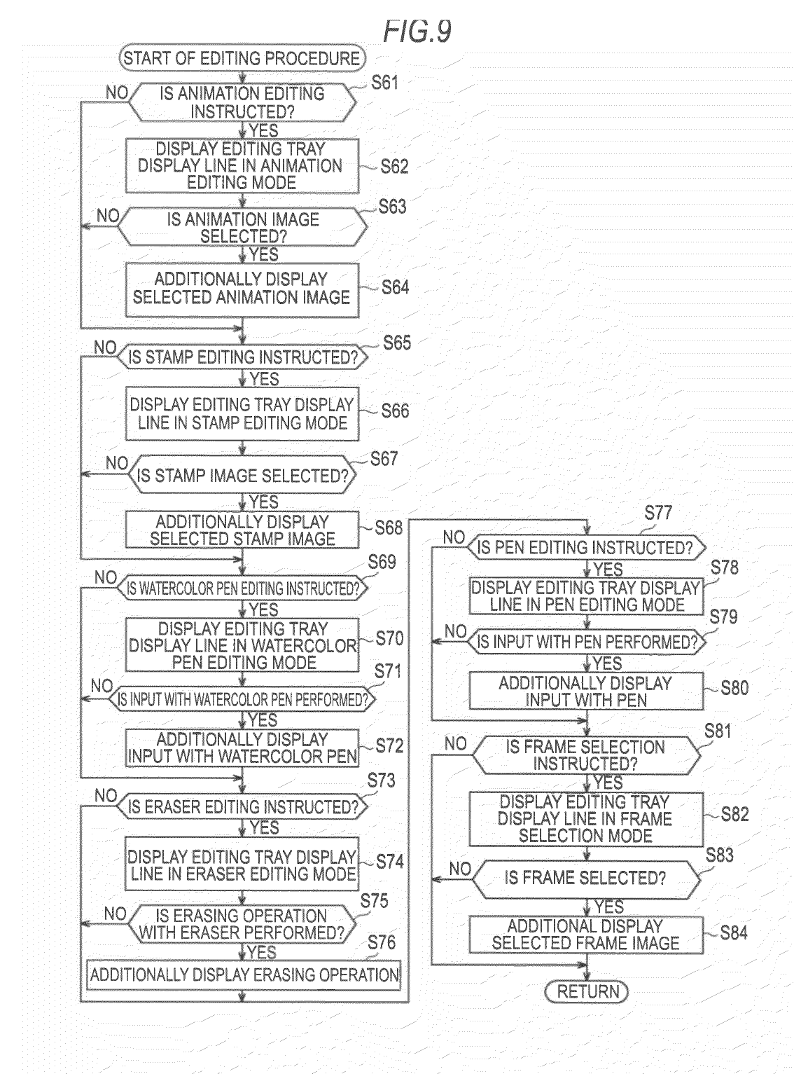

The editing procedure will be described below with reference to the flow diagram shown in FIG. 9.

In step S61, the message editing processor 122 determines whether the animation editing mode is selected by a point not shown by the use of the operation detail recognizer 113. For example, when the stared-stick icon of the editing tool display line 513 shown in FIG. 8 is selected and it is determined in step S61 that the animation editing mode is selected, the procedure goes to step S62.

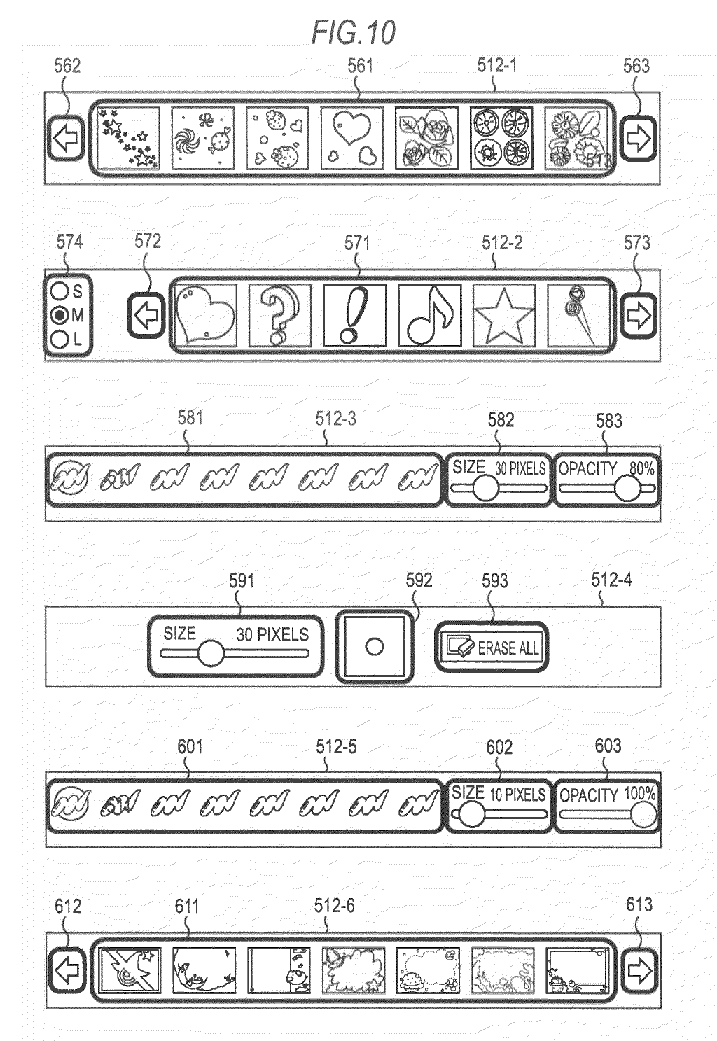

In step S62, the message editing processor 122 switches the display details of the editing tray display line 512 to the editing tray display line 512-1 representing the animation editing mode, for example, as shown in the uppermost stage of FIG. 10. A list display line 561, a return button 562, and a transfer button 563 are displayed in the editing tray display line 512-1 representing the animation editing mode. In FIG. 10, reproduction start images as an animation image are displayed every seven images as a list in the list display line 561, are scrolled to the left whenever the transfer button 563 is operated, are scrolled to the right when the return button 562 is operated. When the user selects a reproduction start image by the use of a pointer not shown, the selected animation image is displayed in the captured image display line 511. The display position of an animation image can be changed by dragging and dropping the animation image with a pointer not shown.

In step S63, the message editing processor 122 determines whether an animation image is selected with a pointer not shown by the use of the operation detail recognizer 113. When it is determined in step S63 that an animation image is selected, the message editing processor 122 displays the selected animation image in the captured image display line 511 in step S64. The animation image may be, for example, an animation image showing that plural balloons are first displayed and then fly away. An animation image showing that the twinkles of starts disappear may be prepared and may be repeatedly displayed. That is, when a dragging operation with a point not shown is performed on the display surface of the display unit 21 of the touch panel 102, the animation image is displayed at the dragged position for the present time just after the dragging and then slowly disappears. By this display, the animation image showing that stars twinkle can be generated to correspond to the dragging operation.

When it is determined in step S61 that the animation editing mode is not selected and when it is determined in step S63 that no animation image is not selected, the procedure goes to step S65.

In step S65, the message editing processor 122 determines whether the stamp editing mode is selected with a point not shown by the use of the operation detail recognizer 113. For example, when the stamp-like icon in the editing tool display line 513 shown in FIG. 8 is selected and it is determined in step S65 that the stamp editing mode is selected, the procedure goes to step S66.

In step S66, the message editing processor 122 switches the display detail of the editing tray display line 512 to an editing tray display line 512-2 representing the stamp editing mode, for example, as shown in the second stage of FIG. 10. A list display line 571, a return button 572, a transfer button 573, and a size selection line 574 are displayed in the editing tray display line 512-2 representing the stamp editing mode. In FIG. 10, six stamp images are displayed every six images as a list in the list display line 571, are scrolled to the left whenever the transfer button 573 is operated, are scrolled to the right when the return button 572 is operated. Selection buttons for the sizes of “small”, “middle”, and “large” are disposed from the upside in the size selection line 574 and “middle” is selected in FIG. 10. When the user selects a stamp image with a pointer not shown, the selected stamp image is displayed in the captured image display line 511. The display position of the stamp image can be changed by dragging and dropping the stamp image with a pointer not shown.

In step S67, the message editing processor 122 determines whether a stamp image is selected with a point not shown by the use of the operation detail recognizer 113. When it is determined in step S67 that a stamp image is selected, the message editing processor 122 displays the selected stamp image in the captured image display line 511 in step S68.

When it is determined in step S65 that the stamp editing mode is not selected and when it is determined in step S67 that any stamp image is not selected, the procedure goes to step S69.

In step S69, the message editing processor 122 determines whether the watercolor pen editing mode is selected with a point not shown by the use of the operation detail recognizer 113. For example, when the brush-like icon of the editing tool display line 513 shown in FIG. 8 is selected and it is determined in step S69 that the watercolor pen editing mode is selected, the procedure goes to step S70.

In step S70, the message editing processor 122 switches the display details of the editing tray display line 512 to an editing tray display line 512-3 representing the watercolor pen editing mode, for example, as shown in the third stage of FIG. 10. A list display line 581, a size line 582, and an opacity line 583 are displayed in the editing tray display line 512-3 representing the watercolor pen editing mode. In FIG. 10, colors of the watercolor pen are displayed every seven colors as a list in the list display line 581. A knob for selecting the thickness is disposed in the size line 582 and the thickness can be set in terms of pixel by moving the knob to the right or left. A knob for selecting the opacity is disposed in the opacity line 583 and the opacity can be set in terms of percentage by moving the knob to the right or left. When the watercolor pen is selected with a point, an image can be drawn in the captured image display line 511 as if the image were drawn with a watercolor pen, with the movement of the pointer depending on the thickness and opacity set with the knobs of the size line 582 and the opacity line 583.

In step 71, the message editing processor 122 determines whether a watercolor pen is selected with a point not shown and the editing operation is performed (an image is drawn) by the use of the operation detail recognizer 113. When it is determined in step S71 that a watercolor pen is selected and the point starts its movement, the message editing processor 122 draws an image in the captured image display line 511 with the selected watercolor pen with the movement of the pointer in step S72.

When it is determined in step S69 that the watercolor editing mode is not selected and it is determined in step S71 that the watercolor editing operation is not performed, the procedure goes to step S73.

In step S73, the message editing processor 122 determines whether the eraser editing mode is selected with a point not shown by the use of the operation detail recognizer 113. For example, when the eraser-like icon in the editing tool display line 513 shown in FIG. 8 is selected and it is determined in step S73 that the eraser editing mode is selected, the procedure goes to step S74.

In step S74, the message editing processor 122 switches the display detail of the editing tray display line 512 to an editing tray display line 512-4 representing the eraser editing mode, for example, as shown in the fourth stage of FIG. 10. A size line 591, an image line 592, and an all erasing button 593 are displayed in the editing tray display line 512-4 representing the eraser editing mode. In FIG. 10, a knob for setting the size to be erased by the editing operation is disposed in the size line 591 and the size is set in terms of pixel by moving the knob to the right or left. A spot with the same size as the size at this time is displayed in the image line 592. That is, the user can set the size while recognizing the erased area at the size of the spot in the image line 592 with the movement of the knob of the size line 591 to the right or left. The all erasing button 593 is a button that is operated to erase all the details drawn in the editing operation. As a result, when the eraser editing mode is selected with the pointer, the editing details drawn in the captured image display line 511 can be erased as if they are erased with an eraser, with the movement of the pointer by the size set with the knob of the size line 591. When the all erasing button 593 is operated, all the editing details are erased.

In step S75, the message editing processor 122 determines whether the eraser editing operation with the set size is performed with a point not shown or the all erasing button 593 is pressed by the use of the operation detail recognizer 113. When it is determined in step S75 that the movement of the point is started or that the all erasing button 593 is pressed, the procedure goes to step S76. That is, in step S76, the message editing processor 122 erases the editing details in the captured image display line 511 with the movement of the pointer by the selected size set in the size line 591 or erases all the editing details.

When it is determined in step S73 that the eraser editing mode is not selected and when it is determined in step S75 that the eraser editing operation is not performed, the procedure goes to step S77.

In step S77, the message editing processor 122 determines whether the pen editing mode is selected with a pointer not shown by the user of the operation detail recognizer 113. For example, when the pen-like icon in the editing tool display line 513 shown in FIG. 8 is selected and it is determined in step S77 that the pen editing mode is selected, the procedure goes to step S78.

In step S78, the message editing processor 122 switches the display detail of the editing tray display line 512 to an editing tray display line 512-5 representing the pen editing mode, for example, as shown in the fifth stage of FIG. 10. A list display line 601, a size line 602, and an opacity line 603 are displayed in the editing tray display line 512-5 representing the pen editing mode. In FIG. 10, colors of the pen are displayed every seven colors as a list in the list display line 601. A knob for selecting the thickness is disposed in the size line 602 and the thickness can be set in terms of pixels by moving the knob to the right or left. A knob for selecting the opacity is disposed in the opacity line 603 and the opacity can be set in terms of percentage by moving the knob to the right or left. When a pen is selected with the pointer, an image can be drawn in the captured image display line 511 as if the image were drawn with an actual pen with the movement of the point by the thickness and opacity set with the knobs in the size line 602 and the opacity line 603.

In step S79, the message editing processor 122 determines whether a pen is selected with the pointer not shown and the pen editing operation is performed (an image is drawn) by the use of the operation detail recognizer 113. When it is determined in step S79 that a watercolor pen is selected and the movement of the point is started, the message editing processor 122 draws an image in the captured image display line 511 with the movement of the pointer with the selected color of a pen in step S80.

When it is determined in step S77 that the pen editing mode is not selected and when it is determined in step S79 that the pen editing operation is not performed, the procedure goes to step S81.

In step S81, the message editing processor 122 determines whether the frame editing mode is selected with a pointer not shown by the use of the operation detail recognizer 113. For example, when the frame-like icon in the editing tool display line 513 shown in FIG. 8 is selected and it is determined in step S81 that the frame editing mode is selected, the procedure goes to step S82.

In step S82, the message editing processor 122 switches the display detail of the editing tray display line 512 to an editing tray display line 512-6 representing the frame editing mode, for example, as shown in the sixth stage of FIG. 10. A list display line 611, a return button 612, and a transfer button 613 are displayed in the editing tray display line 512-6 representing the frame editing mode. In FIG. 10, frame images are displayed every seven images as a list in the list display line 611, are scrolled to the left whenever the transfer button 613 is operated, and are scrolled to the right whenever the return button 612 is operated. When the user selects a frame image with a pointer not shown, the selected frame image is displayed in the captured image display line 511.

In step S83, the message editing processor 122 determines whether a frame image is selected with the pointer not shown by the use of the operation detail recognizer 113. When it is determined in step S83 that a frame image is selected, the message editing processor 122 displays the selected frame image in the captured image display line 511 in step S84.

When it is determined in step S81 that the frame editing mode is not selected and when it is determined in step S83 that any frame image is not selected, the editing procedure is ended.

That is, by the above-mentioned procedure, it is possible to edit the animation image, the stamp image, the watercolor pen, the eraser, the pen, and the frame image in the captured image display line 511. As a result, it is possible to edit the display state of the captured image display line 511 of the window 501-1 shown in FIG. 8 into the display state of the captured image display line 511 of the window 501-2. In the window 501-2 shown in FIG. 8, a stamp image like a persimmon is added to a stamp image like a square memo note in which “Happy Birthday” is drawn with a pen and a stamp image simulating a birthday cake or a present is also added thereto.

That is, when the button 331 instructing to prepare a new message is pressed, the user located in front of the touch panel 102 and captured by the image capturing unit 17 is displayed in the captured image display line 511 of the display unit 21. By operating the operation input unit 18 of the touch panel 102, the user can perform the editing operation while viewing himself displayed in the captured image display line 511. Accordingly, it is possible to perform the editing operation while viewing and enjoying the editing details added to his or her image in real time. When several persons gather in front of the touch panel 102 and the gathered persons are displayed in the captured image display line 511, all the gathered persons can enjoy the editing operation while viewing the editing state. The all the gathered persons can display the finally-prepared image messages on the message board 301 and can enjoy it.

The procedure will be described with reference to FIG. 7 again.

For example, when the captured image display line 511 is edited in the process of step S44 as shown in the window 501-2 of FIG. 8, the procedure goes to step S45. When it is determined in step S43 that the editing operation is not instructed, the process of step S44 is skipped.

In step S45, the still image message generator 123 determines whether the capturing of an image is instructed with a pointer not shown by the use of the operation detail recognizer 113. For example, as shown in the window 501-3 of FIG. 8, when it is determined in step S45 that the pointer 531 is operated to press the button 521 and to instruct the capturing of an image by operating the operation input unit 18, the procedure goes to step S46. The point 531 in the drawing is marked like an icon for the purpose of convenience. In case of the touch panel 102, the pointer 531 is the user's finger coming into contact with the contact portion as the operation input unit 18 of the touch panel 102.

In step S46, the still image message generator 123 reads the captured image currently displayed in the captured image display line 511, generates a new image message including a still image, and registers the new image message in the message data 202 of the storage unit 22, and then the procedure goes to step S54. That is, a still image message or an edited still image message is generated as an image message. At this time, the still image message generator 123 reads the setting information 201 stored in the storage unit 22 and registers the image message, for example, in a folder set in the image folder setting line 451 of the media folder setting window 401-2 shown in FIG. 6. When the editing procedure is being performed on the captured image display line 511, the captured image displayed in the captured image display line 511 along with the editing result is registered as an image message.

In step S54, the message display manager 114 randomly sets the display size, the display position, and the rotation angle by which the newly-registered image message should be displayed.

In step S55, the message display manager 114 reads the newly-registered message data from the storage unit 22 and applies the set display size, display position, and rotation angle to the previously-displayed image message 321. That is, the message display manager 114 displays, for example, like the image message 321-11 in the message board 301-3 in the lower stage of FIG. 8.

By the above-mentioned processes, it is possible to generate an image message using the image presently captured by the image capturing unit 17. At this time, as described above, it is possible to apply the editing procedure to the captured image. In generating an image message, it is possible to perform the editing procedure and to generate a new image message only by the operation with a pointer. As a result, in an electronic apparatus employing the touch panel 102 which, is not suitable for a so-called keyboard input, such as the image processing apparatus 1 according to this embodiment, it is possible to easily edit an image and then to prepare a new image message using the image.

In step S56, the new message registration manager 111 determines whether it is instructed to end the new message preparing procedure with a pointer not shown by the use of the operation detail recognizer 113. For example, when the pointer not shown is operated by the operation input unit 18 to press the button 523 and it is accordingly determined in step S56 that it is instructed to end the new message preparing procedure, the procedure is ended. When it is determined in step S56 that it is not instructed to end the new message preparing procedure, the procedure is returned to step S42.

When it is determined in step S45 that it is not instructed to capture an image, the moving image message generator 124 determines whether it is instructed to record an image with a pointer not shown by the use of the operation detail recognizer 113 in step S47. For example, when it is determined in step S47 that the button 522 is pressed with the pointer 531 from the state of the window 501-11 shown in FIG. 10 as shown in the window 501-12 in the second stage of FIG. 10, it is considered that it is instructed to record an image and thus the procedure goes to step S48. The window 501-11 shown in FIG. 10 is in the same state as the window 501-1 shown in FIG. 8.

In step S48, the moving image message generator 124 starts recording the image currently captured by the image capturing unit 17 and sequentially stores the recorded image, for example, in a folder set in the video folder setting line 452 in the media folder setting window 401-2 shown in FIG. 6.

In step S49, similarly to the process of step S43, the message editing processor 122 determines whether the operation input unit 18 of the touch panel 102 is operated to instruct to perform an editing operation by the use of the operation detail recognizer 113. That is, when the editing tool display line 513 or the editing tray display line 512 displayed on the display unit 21 of the touch panel 102 is operated by the operation input unit 18 to instruct to perform the editing operation, the procedure goes to step S50 and the editing procedure is performed. The editing procedure in step S50 is the same as the editing process in step S44 and thus description thereof is not made.

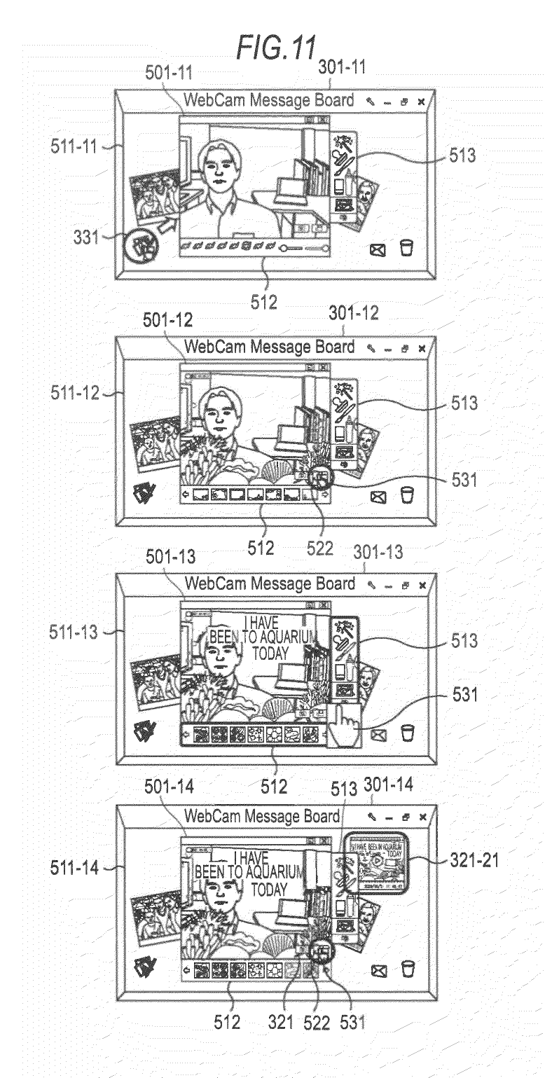

That is, when an undersea-coral-like frame image is added, for example, as shown in the captured image display line 511-12 of FIG. 11 and then it is instructed to start the recording by the process of step S44, the recording is started from the state where the frame image is added. When a text “I have been to an aquarium today” is input in the pen editing mode or the like by the editing procedure of step S50 as shown in the captured image display line 511-13, the course of drawing the text “I have been to an aquarium today” is recorded.

In step S51, the moving image message generator 124 determines whether it is instructed to end the recording with a pointer not shown by the use of the operation detail recognizer 113. When it is not instructed to end the recording, the procedure is returned to step S48. That is, the processes of steps S48 to S51 are repeated until it is instructed to end the recording. When it is determined in step S51 that the button 522 is pressed with the pointer 531, for example, as shown in the window 501-14 in the lowest stage of FIG. 10, it is considered that it is instructed to end the recording and the procedure goes to step S52.

In step S52, the moving image message generator 124 ends the recording of the image currently captured by the image capturing unit 17.

In step S53, the moving image message generator 124 generates an image message on the basis of the recorded moving image data and registers the generated image message in the message data 202 of storage unit 22. At this time, the moving image message generator 124 reads the setting information 201 stored in the storage unit 22 and registers the image message, for example, in a folder set in the video folder setting line 452 of the media folder setting window 401-2 shown in FIG. 6.

By the processes of steps S54 and S55, the image message 321-21 including the newly-prepared moving image is displayed as shown in the message board 301-14 shown in FIG. 11. At this time, for example, the final frame image of the moving image data is displayed in the image message 321-21.

When it is determined in step S47 that it is not instructed to record an image, the processes of steps S48 to S55 are skipped.

By the above-mentioned processes, it is possible to generate the image message using the moving image currently captured and recorded by the image capturing unit 17. At this time, as described above, it is possible to perform the editing procedure on the image currently captured. In generating the image message, it is possible to perform the editing procedure and to generate a new image message only by the operation with a pointer (the contact operation of the operation input unit 18 of the touch panel 102). It is possible to generate the image message reflecting the editing procedure until the recording is ended after the recording is started. As a result, in an electronic apparatus employing the touch panel 102, which is not suitable for the so-called keyboard input, such as the image processing apparatus 1 according to this embodiment, it is possible to easily edit the moving image and to newly prepare the image message using the moving image. When an audio is set to be added to the image message using the moving image by the setting of the check box 431 shown in FIG. 6, it is possible to generate the image message including audio data along with the moving image.

It is possible to perform a desired editing operation while the user views the editing state using the image currently captured by the image capturing unit 17 in real time, to generate an image message, and to display and enjoy the generated image message on the message board 301. For example, when the entire family seats at a position which can be captured by the image capturing unit 17, the entire family can edit the still image or the moving image as they wants to generate an image message and can display and enjoy the generated image message on the message board.

The procedure will be described with reference to FIG. 3 again.

When it is determined in step S6 that it is not instructed to prepare a new message, the process of step S7 is skipped.

In step S8, the reproduction processor 115 determines whether an operation of displaying the image message 321 is performed with a pointer not shown by the use of the operation detail recognizer 113. For example, when it is determined in step S8 that the operation of displaying the image message 321 is performed, the procedure goes to step S9 and a message display operating procedure is performed.

### [Message Display Operating Procedure]

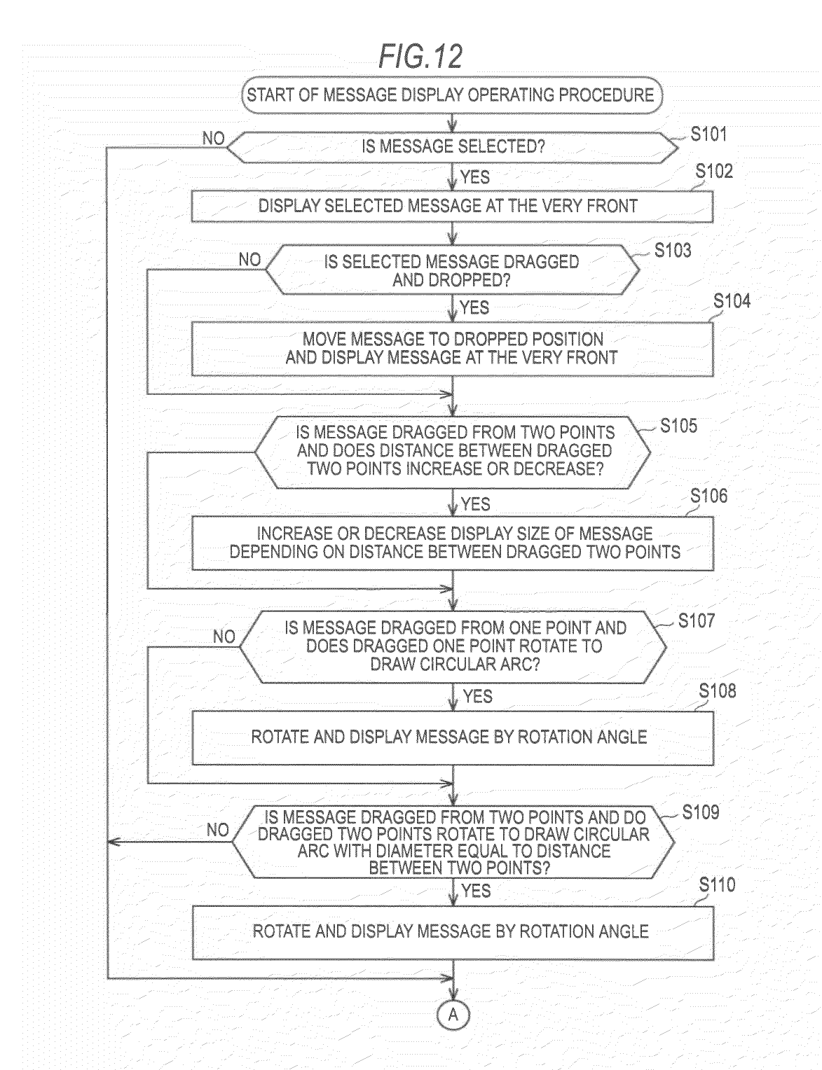

The message display operating procedure will be described below with reference to the flow diagrams of FIGS. 12 to 15.

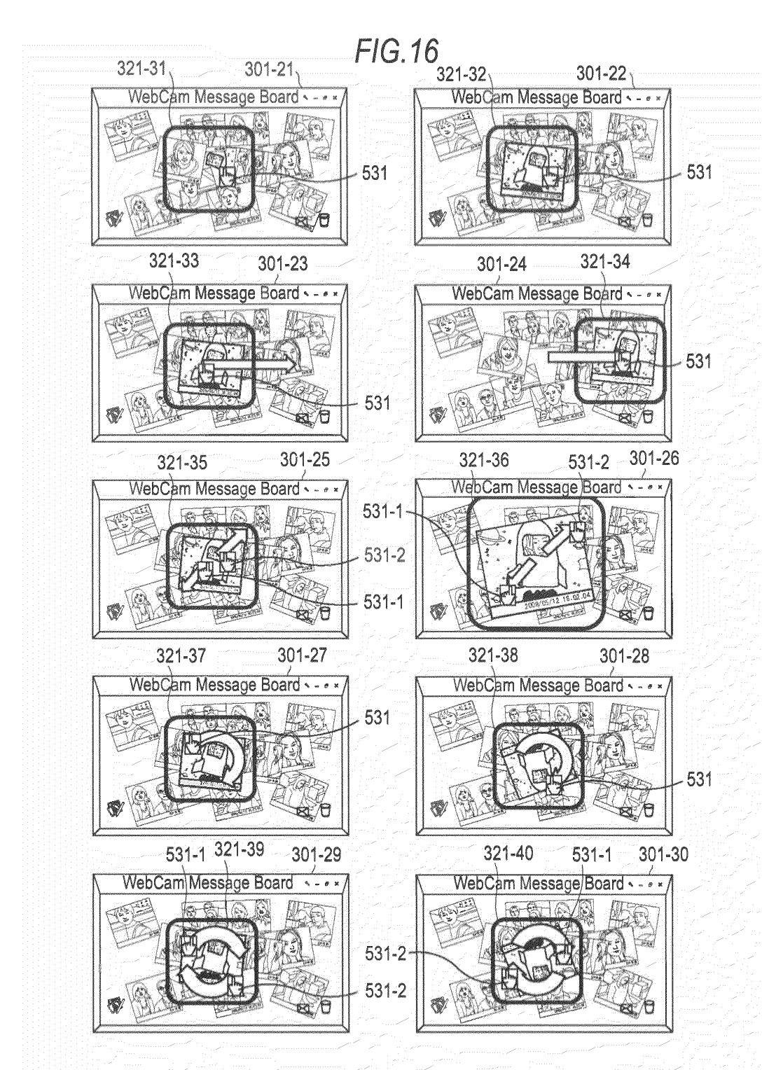

In step S101, the still image message reproduction processor 172 of the reproduction processor 115 determines whether one of the image messages 321 is selected with the pointer 531 by the use of the operation detail recognizer 113. For example, when the still image message reproduction processor 172 determines that the image message 321-31 is selected with the pointer 531 as shown in the message board 301-21 in the uppermost stage of FIG. 16, the procedure goes to step S102.

In step S102, the still image message reproduction processor 172 changes the display so that the selected image message is located at the very front of the other image messages 321 as shown in the image message 321-32 of the message board 301-22 shown in FIG. 16. That is, the hierarchical levels of the image messages 321 are managed in time series as default by the hierarchy manager 158 and the image messages are displayed in such an order of hierarchical levels that the oldest image message is located at the very back and the newest image message is located at the very front. However, the selected image message is set to the lowest hierarchical level by the hierarchy manager 158. As a result, the selected image message 321 is displayed at the very front and the selected image message 321 is emphasized and displayed. At this time, the highlight display controller 155 highlights the selected image message 321. By this process, the image message including a still image is actually reproduced.

In step S103, the moving operation processor 151 of the message display manager 114 determines whether the selected image message 321 is dragged and dropped with the pointer 531 by the use of the operation detail recognizer 113. For example, as shown in the message board 301-23 of FIG. 16, when it is determined in step S103 that the image message 321-33 is dragged, moved to the right in the drawing, and dropped with the pointer 531, the procedure goes to step S104.

In step S104, the moving operation processor 151 displays the image message 321-34 at the position where the image message is dropped with the end of the movement, as shown in the message board 301-24 of FIG. 16. That is, by this procedure, it is possible to freely move and display the image messages 321 in the message board 301.

When it is determined in step S103 that the selected image message is not dragged and dropped, the process of step S104 is skipped.

In step S105, the enlarging and reducing operation processor 152 of the message display manager 114 determines whether the selected image message 321 is dragged from two points with the pointers 531 and the distance between two points increases or decreases by the use of the operation detail recognizer 113. For example, as shown in the message board 301-25 of FIG. 16, when it is determined in step S105 that the image message is dragged from two points with the pointers 531-1 and 531-2 and the distance between two points is enlarged, the procedure goes to step S106.

In step S106, the enlarging and reducing operation processor 152 enlarges and displays the image message 321-36 depending on the distance between two points as shown in the message board 301-26 of FIG. 16. When it is determined that the distance between two points decreases, the image message 321-36 is displayed with a decreased size depending on the distance between two points. That is, by this process, the image messages 321 can be freely changed in size and displayed on the message board 301.

When it is determined in step S105 that an image message is not dragged from two points or the distance between two points does not increase or decrease, the process of step S106 is skipped.

In step S107, the rotating operation processor 153 of the message display manager 114 determines whether the selected image message 321 is dragged from one point and is rotated to form a circular arc with the pointer 531 by the use of the operation detail recognizer 113. That is, it is determined whether the selected image message 321 is dragged from one point at the outer edge of the display area of the image message 321 and is rotated to form a circular arc about the center of the display area of the image message 321 with the pointer 531. For example, as shown in the message board 301-27 of FIG. 16, when it is determined in step S107 that the image message is dragged from one point and is rotated to form a circular arc about a predetermined position with the pointer 531, the procedure goes to step S108.

In step S108, the rotating operation processor 153 rotates and displays the image message 321 by the rotation angle of the dragged position, as shown in the image message 321-38 of FIG. 16. That is, by this process, the image message 321 can be freely changed in rotation angle and displayed on the message board 301.

When it is determined in step S107 that the image message is not dragged from one point or is not rotated to form a circular arc, the process of step S108 is skipped.

In step S109, the rotating operation processor 153 of the message display manager 114 determines whether the image message 321 is dragged from two points and is rotated about the center position between two points with a radius which is the distance between two points by the use of the operation detail recognizer 113. That is, it is determined whether the image message is dragged from two points in the outer edge of the display area of the image message 321 and is rotated about the center position between two points with a radius which is the distance between two points. For example, as shown in the message board 301-29 of FIG. 16, when it is determined in step S109 that the image message is dragged from two points and is rotated about the center position between two points with a radius which is the distance between two points with the pointers 531-1 and 531-2, the procedure goes to step S110.

In step S110, the rotating operation processor 153 rotates and displays the image message 321-39 depending on the rotation angle of the dragged position as shown in the image message 321-40 of FIG. 16. That is, by this process, the image messages 321 can be freely changed in rotation angle and displayed on the message board 301.

When it is determined in step S109 that the image message is not dragged from two points or is not rotated about the center position between two points to form a circular arc with a radius which is the distance between two points, the process of step S110 is skipped.

That is, by the above-mentioned processes, in an electronic apparatus employing the touch panel 102, an image message displayed on the touch panel 102 can be moved, enlarged, reduced, or rotated in the contact direction only by coming into contact with the image message with a finger tip through the use of the operation input unit 18. The above-mentioned operations on an image message may be performed by combination. For example, the enlarging or reducing operation may be performed while performing the rotating operation.

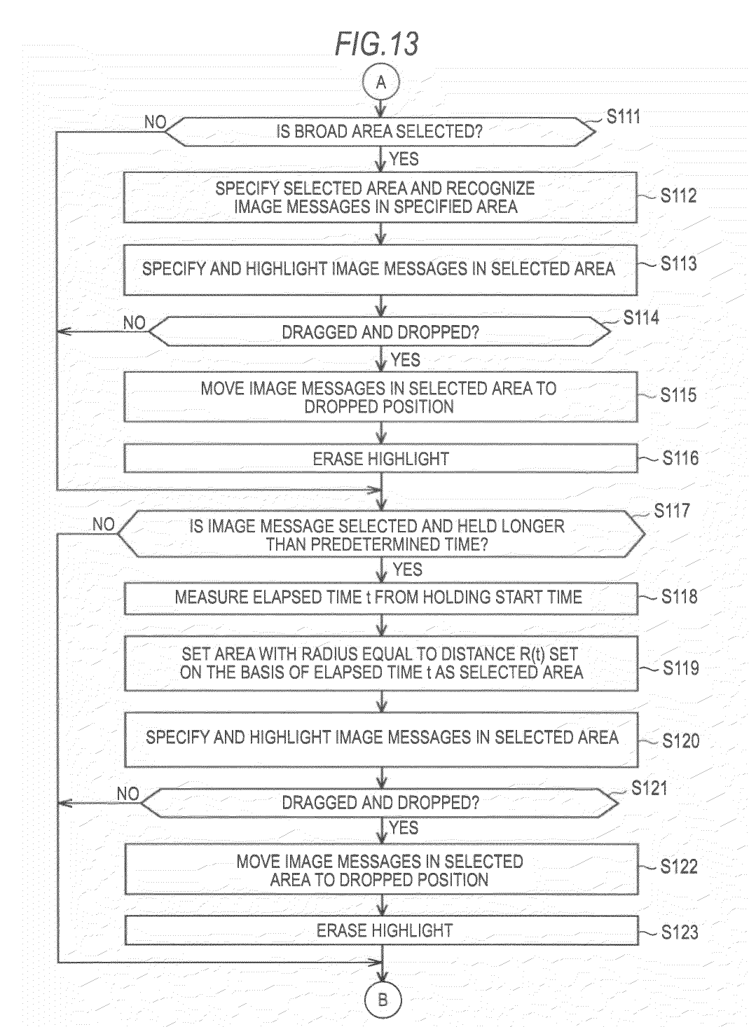

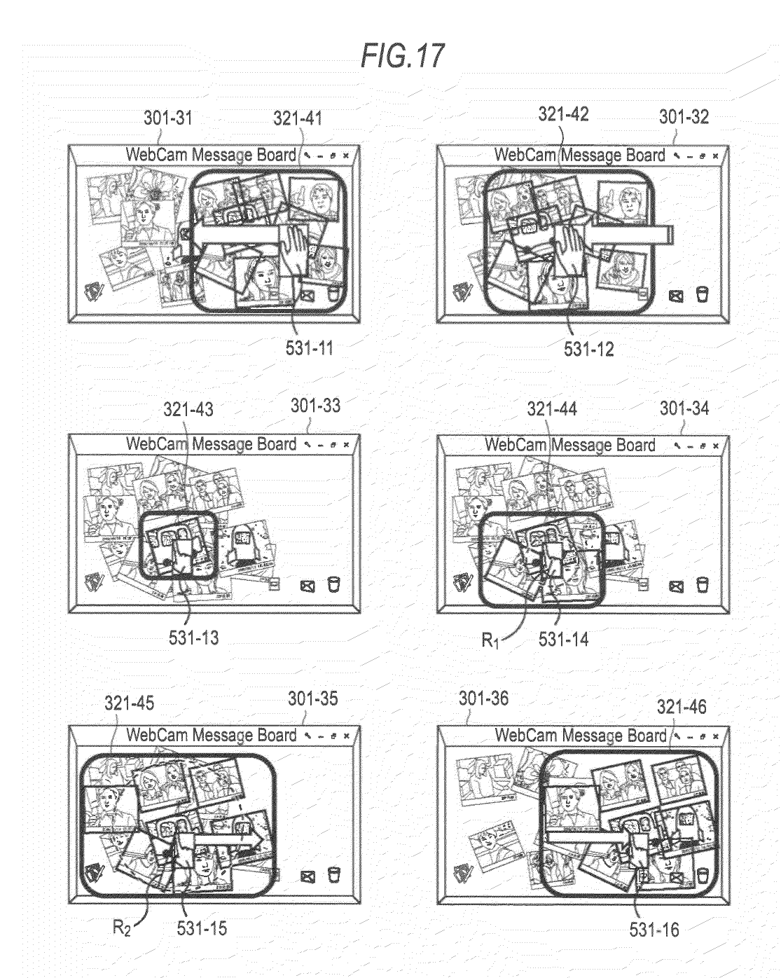

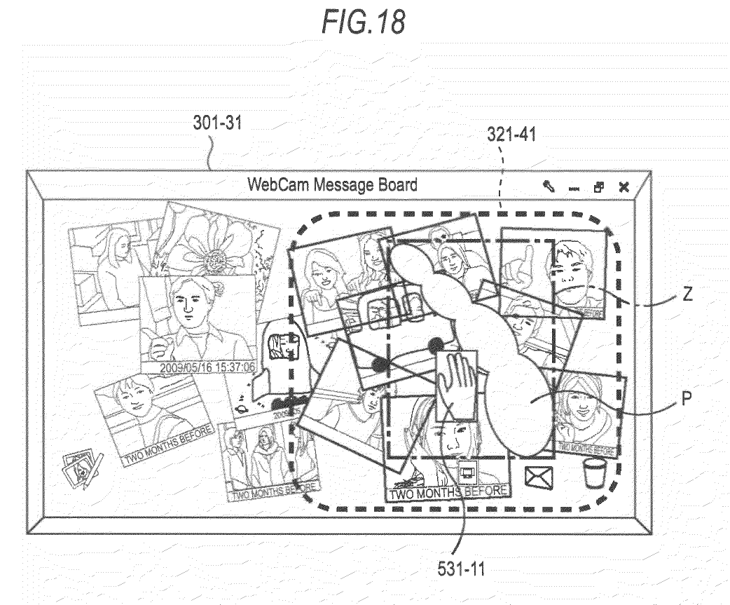

In step S111 (FIG. 13), the message display manager 114 controls the operation area recognizer 154 to determine whether a broad area including the image message 321 and being greater than a predetermined area is selected with the pointer 531 by the use of the operation detail recognizer 113. For example, as shown in the message board 301-31 in the uppermost stage of FIG. 17, when it is determined in step S111 that the broad area shown in the image message 321-41 is selected with the pointer 531-11, the operation area recognizer 154 considers that the broad area is selected and the procedure goes to step S112. More specifically, when an area broader than the area of the finger tip, as indicated by the palm P in FIG. 18, is selected in the display area of the message board 301-31, it is considered that the broad area is selected. FIG. 18 is an enlarged view of the message board 301-31, where the palm P simulates the contact area, for example, when the palm of the right hand stands upright with the little finger directed downward and comes into contact with the display unit 21 (the operation input unit 18) of the touch panel 102 corresponding to the paper surface of FIG. 18.

In step S112, the operation area recognizer 154 recognizes the broad operation area on the basis of the operation details of the operation detail recognizer 113 including the information on the area measured by the area measurer 102a of the touch panel 102. That is, for example, in FIG. 18, the operation area Z corresponding to the contact area of the palm P on the message board 301-31 is recognized. The operation area Z is an area including the contact area indicated by the palm P and is a rectangular area having the longest parts in the horizontal direction and the vertical direction as four sides.

In step S113, the area specifying section 157 specifies the image message 321 to be selected on the basis of the operation area Z recognized by the operation area recognizer 154. For example, in FIG. 18, the area specifying section 157 specifies eight image message 321 of which parts are included in the operation area Z as an image message group 321-41 in a selected area. The highlight display controller 155 highlights all the eight image messages 321 specified as the selected area. In the drawing, the highlight of the image messages 321 is indicated by a thick line frame.

In step S114, the moving operation processor 151 of the message display manager 114 determines whether the selected image messages 321 are dragged and dropped with the pointer 531 by the use of the operation detail recognizer 113. For example, as shown in the message board 301-32 of FIG. 17, when it is determined in step S114 that the image messages 321-42 are dragged, moved to left in the drawing, and dropped with the pointer 531-12, the procedure goes to step S115.

In step S115, the moving operation processor 151 displays the group of plural image messages 321-42 at the position where the image messages are dropped with the end of the movement, as shown in the message board 301-32 of FIG. 18.

In step S116, the highlight display controller 155 erases the highlight display of the image messages 321 in the recognized operation area.

When it is determined in step S111 that the broad area is not selected or when it is determined in step S114 that the image messages are not dragged and dropped, the procedure goes to step S117.

By the above-mentioned processes, the plural image messages 321 on the message board 301 can be freely moved and displayed as an image message group by once operation. That is, as if photographs existing on an actual message board were scattered and gathered with a palm, the plural image messages 321 on the message board 301 can be moved as an image message group. As a result, it is possible to operate the image messages with the same feeling as managing actual photographs.

In step S117, the message display manager 114 controls the holding time measurer 156 to measure the elapsed time t in the state where an image message 321 is selected with the pointer 531 by the use of the operation detail recognizer 113. Then, the message display manager 114 determines whether the elapsed time t is longer than a predetermined time T1. When it is determined in step S117 that the elapsed time t is longer than the predetermined time T1, the message display manager 114 controls the holding time measurer 156 to further measure the elapsed time t in step S118.

In step S119, the message display manager 114 controls the operation area recognizer 154 to recognize a circular area with a radius equal to the distance R(t) set on the basis of the elapsed time t as the operation area.

In step S120, the area specifying section 157 specifies the image messages 321 of which parts are included in the circular operation area with a radius of the distance R(t) recognized by the operation area recognizer 154 as an image message group to be selected. At this time, when plural image messages overlap, the area specifying section 157 specifies only the image messages 321 having high hierarchical levels (front), which are managed by the hierarchy manager 158, that is, the image messages displayed on the front surface as the image messages 321. The highlight display controller 155 highlights the specified image messages 321.

For example, when a predetermined time t1 elapses in the state where an image message is pointed with the pointer 531-13 of the message board 301-33 of FIG. 17, the area specifying section 157 recognizes a circular operation area with a radius expressed by a distance R1 (=R(t1)) indicated by a dotted line of the pointer 531-14 in the message board 301-34. The image messages 321 of which parts are included in the circular operation area with a radius R1 are specified as the image message group in the selected area. For example, when time passes by an elapsed time t2 (>t1), a circular operation area with a radius expressed by a distance R2 (=R(t2)) indicated by a dotted line in the message board 301-35 in FIG. 17 is recognized.

The area specifying section 157 specifies the image messages 321 of which parts are included in the circular operation area with a radius of the distance R2 as the image message group in the selected area. As a result, when the elapsed time after the image message is selected with the pointer 531-13 is an elapsed time T1 and is held with the pointer 531-14 at the same position as the pointer 531-13, three image messages 321 highlighted (a large frame is added to the images) are specified as the selected area as shown in the image message group 321-44. When the pointer 531-15 is held in the same position as the pointer 531-13 and time further elapses by an elapsed time T2, seven image messages 321 are selected as shown in the image message groups 321-45. When the state where the same image message is held is continuously maintained, the image messages specified as the selected area increase about the selected image message depending on the elapsed time t to construct the image message group.

In step S121, the moving operation processor 151 of the message display manager 114 determines whether the selected image message group 321-45 is dragged and dropped with the pointer 531-15 by the use of the operation detail recognizer 113. For example, as shown in the message board 301-35 of FIG. 17, when it is determined in step S121 that the image message group 321-45 is dragged, moved to the right, and dropped with the pointer 531-15, the procedure goes to step S123.

In step S122, the moving operation processor 151 displays the image message group 321-46 including plural image messages 321 at the position where the image message group is dropped with the end of the movement, as shown in the message board 301-36 of FIG. 17.

In step S123, the highlight display controller 155 erases the highlight display of the image messages 321 in the recognized selected area.

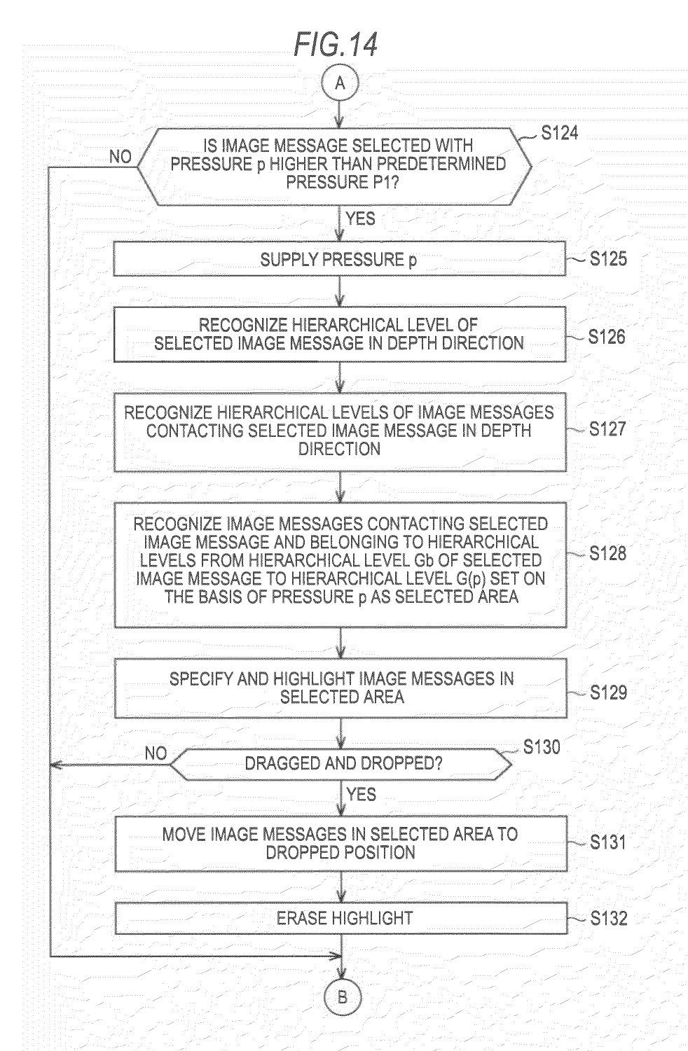

When it is determined in step S117 that the elapsed time is not longer than the predetermined time T1 or when it is determined in step S121 that the image message group is not dragged and dropped, the procedure goes to step S124 (FIG. 14).

By the above-mentioned processes, when an image message 321 displayed in the message board 301 is selected and the holding state is maintained, the number of image messages 321 to be selected increases from the held image message 321 depending on the elapsed time t. At this time, since only the image messages on the front surface of which the hierarchical levels managed by the hierarchy manager 158 are high are selected, it is possible to select only the images which can be visually confirmed by the user. As a result, the user can select and operate plural image messages by one contact operation on the touch panel 102. All the image messages existing in the circular operation area with the radius set depending on the elapsed time t about the image message in the holding state may be selected. The operation area may be changed depending on the elapsed time of the holding state. Accordingly, for example, depending on the elapsed time t of the holding state, the image messages 321 of which a part is included in the operation area may be gathered and displayed at the same position as the selected and held image message.

In step S124 (FIG. 14), the message display manager 114 acquires information of a pressure p applied by the operation on the operation input unit 18 and measured by the pressure measurer 102b of the touch panel 102 in the state where an image message 321 is selected. The message display manager 114 determines whether the acquired pressure p is higher than a predetermined pressure P1. When it is determined in step S124 that the pressure p is higher than the predetermined pressure P1, the message display manager 114 acquires information of the operation position at which the pressure based on the operation and being higher than the predetermined pressure P1 is generated and information of the measured pressure p and supplies the information to the area specifying section 157 in step S125.

In step S126, the area specifying section 157 inquires the hierarchy manager 158 and recognizes the hierarchical level G in the depth direction of the image message 321 existing at the corresponding position on the basis of the information of the operation position.

In step S127, the area specifying section 157 inquires the hierarchy manager 158 and recognizes the hierarchical levels Gm in the depth direction of all the image messages 321 contacting the image message 321 existing at the operation position on the basis of the information of the operation position. Here, m represents an identifier identifying the plural image messages 321 contacting the image message 321 existing at the operation position. The area specifying section 157 acquires the hierarchical level of the image message 321 existing at the operation position and the hierarchical levels of the image messages 321 contacting the image message 321 on the basis of the information of the hierarchical levels managed by the hierarchy manager 158 and acquires the hierarchical levels.

In step S128, the area specifying section 157 recognizes the hierarchical level G(P) set on the basis of the pressure p as the selected area.

In step S129, the area specifying section 157 specifies all the image messages 321 up to the hierarchical level G(p) as the image messages 321 to be selected. The highlight display controller 155 highlights the specified image messages 321.

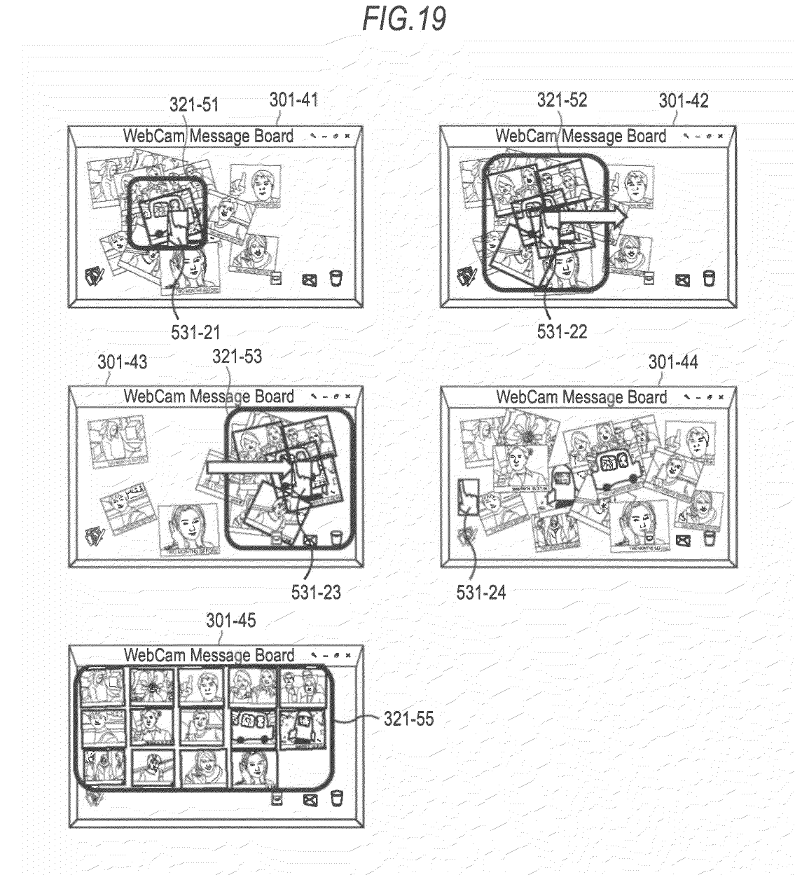

For example, when the pointer 531-21 in the message board 301-41 of FIG. 19 is operated with a pressure p lower than a predetermined pressure P1, the area specifying section 157 recognizes only the image message 321-51 pointed with the pointer 531-21 as the selected area. This process is the process of step S101. That is, the process of step S101 is on the condition that the pressure p is lower than the predetermined pressure P1.

On the other hand, for example, when the pointer 531-22 in the message board 301-42 of FIG. 19 is operated with a pressure p higher than the predetermined pressure P1, the area specifying section 157 recognizes the image message group 321-52 including the image messages up to the hierarchical level G(p) set depending on the pressure p among the image messages contacting with the image message 321 located at the position pointed with the pointer 531-22 as the selected area. Accordingly, as the operation pressure of the pointer 531-22 is lowered, the hierarchical level G(p) set to correspond to the pressure p is lowered and only the image message 321 having the higher hierarchical levels are specified. Accordingly, the number of image messages 321 specified as the image message group decreases.

On the contrary, as the operation pressure of the pointer 531-22 is raised, the hierarchical level G(p) set to correspond to the pressure p is raised and the image messages 321 having the lower hierarchical levels are selected. That is, as the pressure becomes higher, more image messages 321 can be set as the selected area and the number of image messages of the image message group increases. The image message group 321-52 includes five image messages 321.

In step S130, the moving operation processor 151 of the message display manager 114 determines whether the selected image message 321 is dragged and dropped with the pointer 531 by the use of the operation detail recognizer 113. For example, as shown in the message board 301-42 of FIG. 19, when it is determined in step S130 that the image message 321-52 is dragged, moved to the right in the drawing, and dropped with the pointer 531-22, the procedure goes to step S131.

In step S131, the moving operation processor 151 displays plural image messages 321-53 at the position where the image messages are dropped with the end of the movement with the pointer 531-23, as shown in the message board 301-43 of FIG. 19.

In step S132, the highlight display controller 155 erases the highlight display of the image messages 321 in the recognized selected area.

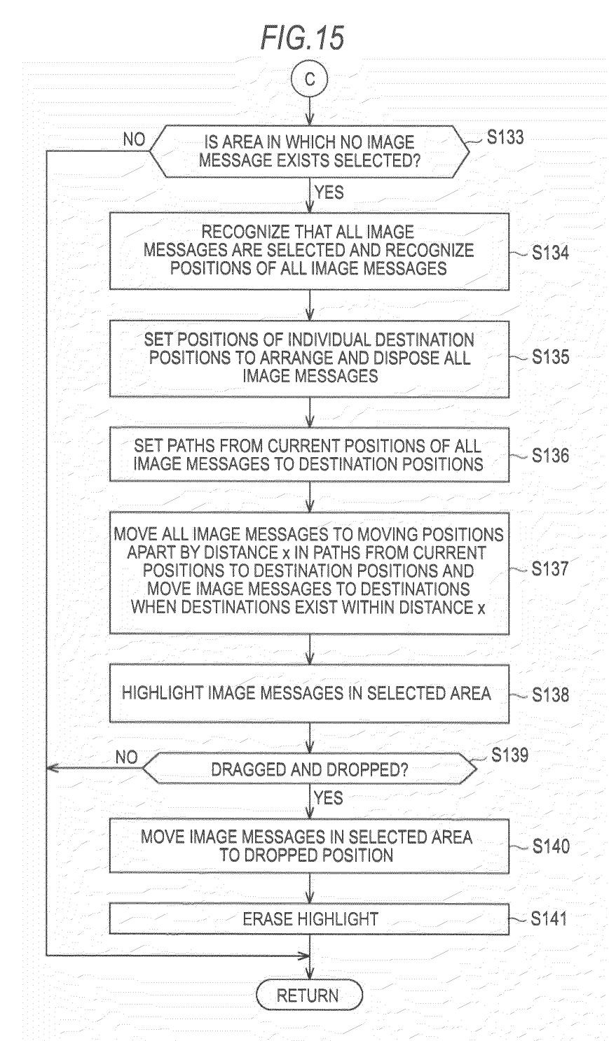

When it is determined in step S124 that the pressure p is not higher than the predetermined pressure P1 or when it is determined in step S130 that the selected image message is not dragged and dropped, the procedure goes to step S133 (FIG. 15).

By the above-mentioned processes, when an image message 321 displayed on the message board 301 is selected and held, the image messages up to the hierarchical level G(p) set depending on the pressure p in the holding state among the image messages 321 contacting the held message 321 to overlap with each other are considered as the selected area. Accordingly, the user can select as the selected area the image messages based on the hierarchical level G(p) among the image messages contacting the held image message with the held image message as the center by adjusting the contact pressure p applied to the touch panel 102. At this time, since the selected image messages 321 are highlighted, it is possible to adjust the image messages which it is wanted to include in the selected area as the image message group by changing the pressure p while confirming the selected image message 321.

As a result, the user can select and operate plural image messages by one contact operation with the touch panel 102. Since the image messages set as the selected area can be changed depending on the pressure p in the holding state, the image messages set as the selected area depending on the pressure p in the holding state may be gathered and displayed at the same position as the selected and held image message. The image messages existing in the circular area with a radius of the distance R(p) set depending on the pressure p with the held image message as the center may be set as the selected area as in the above-mentioned processes of steps S117 to S123. In the above-mentioned processes of step S117 to S123, the image messages existing in the circular area with a radius of the distance R(t) set depending on the holding time t are set as the selected area, but the hierarchical level G(t) may be set depending on the holding time t and the image messages up to the hierarchical level G(t) may be set as the selected area as in the processes of steps S125 to S132.

In step S133 (FIG. 15), the message display manager 114 determines whether a position where any image message 321 does not exist is selected. For example, when it is determined in step S133 that a position where any image message 321 does not exist is selected, the message display manager 114 notifies the area specifying section 157 of the determination result in step S134. The area specifying section 157 recognizes that all the image messages are selected and confirms the positions of all the image messages 321.

In step S135, the destination setter 159 sets the destination positions of the image messages 321 to be arranged and displayed on the basis of the information of the positions of all the image messages 321 recognized by the area specifying section 157. The arrangement order in which the image messages 321 are arranged and displayed may be the order of the hierarchical levels managed by the hierarchy manager 158 or the order of identifiers of the image messages or the order of preparation dates.

In step S136, the path setter 160 sets moving paths on the message board 301 of the image messages 321 from the positions of all the image messages 321 recognized by the area specifying section 157 to the destinations set by the destination setter 159. That is, the set paths may be the linear shortest paths from the current positions to the destinations or other irregular paths.

In step S137, the moving position setter 161 moves the image messages 321 to the moving positions which are apart by the moving distance x along the paths set by the path setter 160. When the distances set as the moving paths are longer than the moving distance x, the image messages are moved only to the destinations.

In step S138, the highlight display controller 155 highlights all the image messages 321.

That is, for example, as shown in the pointer 531-24 of the message board 301-44 of FIG. 19, when a position where any image message 321 does not exist on the message board 301 is selected and the moving distance x is sufficiently large, all the image message 321 are displayed in the selected and arranged state as shown in the image message group 321-55 of the message board 301-45 of FIG. 19.

In step S139, the moving operation processor 151 of the message display manager 114 determines whether the selected image messages 321 are dragged and dropped with the pointer 531 by the use of the operation detail recognizer 113. For example, when it is determined in step S139 that all the image messages 321 are dragged, moved in any direction, and dropped with the pointer 531, the procedure goes to step S140.

In step S140, the moving operation processor 151 displays the plural image messages 321 at the position where the image messages are dropped with the end of the movement.

In step S141, the highlight display controller 155 erases the highlight display of the image messages 321 in the recognized operation area.

When it is determined in step S133 that a position in which any image message does not exist is not selected or when it is determined in step S139 that the image messages are not dragged and dropped, the procedure is ended.

According to the above-mentioned configuration, by the operation not selecting any image message, it is possible to set all the image messages as the selected area and to arrange and display all the messages. As a result, the user can select, arrange, and operate all the image messages by one contact operation with the touch panel 102.

The moving distance x can be arbitrarily set. Accordingly, when the moving distance x is set to be smaller than that of the moving paths, the image messages 321 are not changed to the image messages 321-55 as the destinations but are moved to the positions which are apart by the moving distance x from the current positions along the moving paths. However, as shown in the pointer 531-24 of the message board 301-44 of FIG. 19, when the position where any image message does not exist on the message board 301 is selected again, the image messages are moved by the moving distance x along the moving paths. In this way, by repeatedly performing the operation not selecting any image message 321, the image messages slowly get close to the arranged state and are finally changed to the state of image messages 321-55. That is, the user can display all the image messages to slowly be arranged by repeatedly performing the operation selecting the position where any image message does not exist so as to knock on the touch panel 102, thereby giving a margin to the operation.

The procedure will be described with reference to FIG. 3 again.

When it is determined in step S8 that the operation of displaying an image message is not performed, the process of step S9 is skipped.

In step S10, a moving image reproduction processor 171 of the reproduction processor 115 determines whether the play button of the image message 321 is pressed with a pointer not shown to instruct to reproduce the image message by the use of the operation detail recognizer 113. For example, when it is determined in step S10 that the play button of the image message 321 is pressed to instruct to reproduce the image message, the procedure goes to step S11 and the message reproducing procedure is performed.

### [Message Reproducing Procedure]

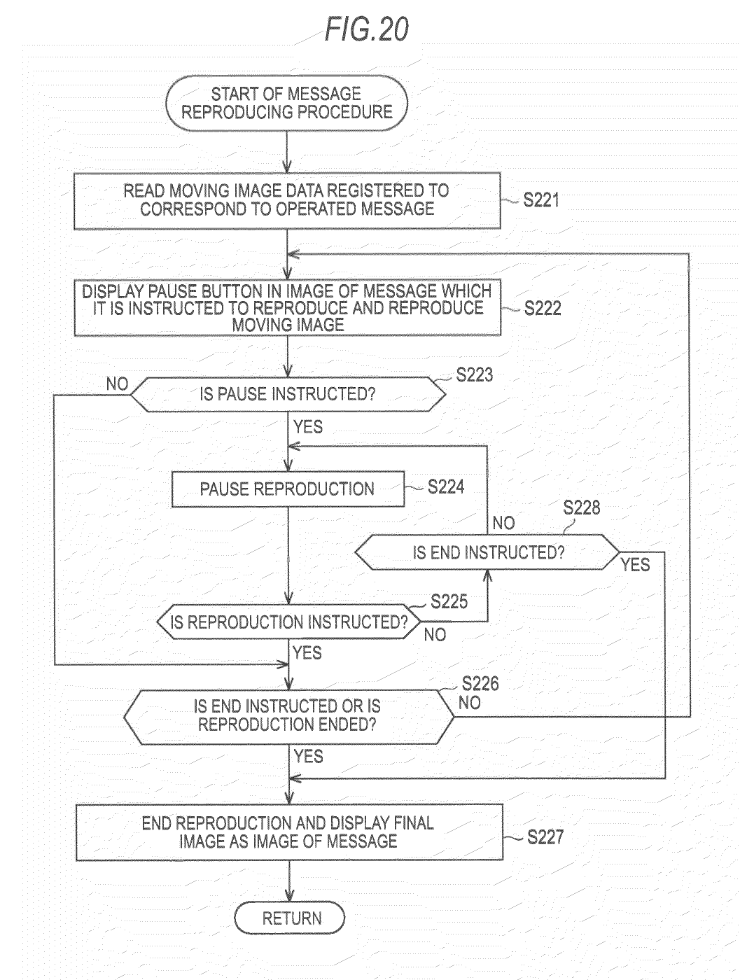

The message reproducing procedure will be described below with reference to the flow diagram shown in FIG. 20.

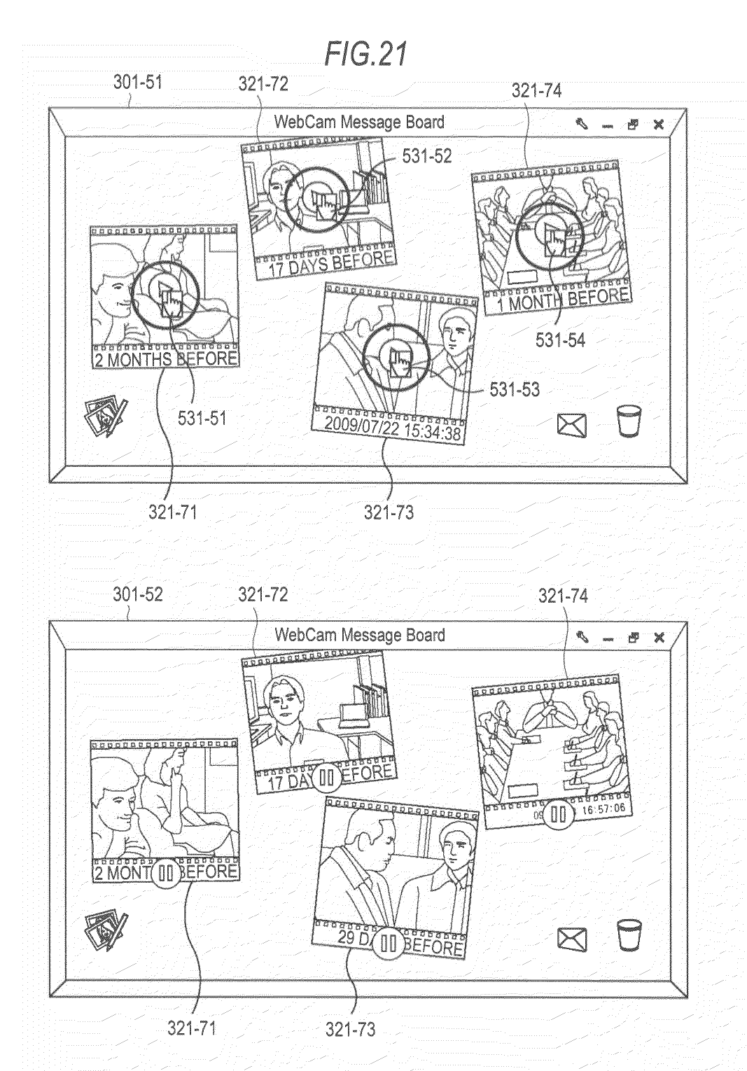

In step S221, when the play button is operated as shown in the pointer 531-51 in the image message 321-71 of FIG. 21, the moving image reproduction processor 171 reads the message data 202 corresponding to the image message 321-71 from the storage unit 22.

In step S222, the moving image reproduction processor 171 reproduces and displays the read moving image data in the image message 321-71 as shown in the lower stage of FIG. 21. At this time, the moving image reproduction processor 171 also displays a pause button in which two vertical rods are arranged horizontally, as shown in the lower stage of FIG. 21.

In step S223, the moving image reproduction processor 171 determines whether the pause button is pressed with a pointer not shown to instruct to pause the reproduction by the use of the operation detail recognizer 113.

When it is determined in step S223 that the pause button is pressed, the moving image reproduction processor 171 displays the image message 321-71 of a still image including a frame image at the time of stopping the reproduction and also displays the play button in step S224 as shown in the upper stage of FIG. 21.

In step S225, the moving image reproduction processor 171 determines whether the play button is pressed. When it is determined in step S225 that the play button is not pressed, the procedure goes to step S228. In step S228, the moving image reproduction processor 171 determines whether it is instructed to end the reproduction of the moving image. When it is determined in step S228 that it is instructed to end the reproduction of the moving image, the procedure goes to step S227. On the other hand, when it is determined in step S228 that it is not instructed to end the reproduction of the moving image, the procedure is returned to step S224. That is, until it is instructed to end the reproduction of the moving image or the play button is pressed, the processes of steps S224, S225, and S228 are repeatedly performed. When it is determined in step S225 that the reproduction is instructed, the procedure goes to step S226.

In step S226, the moving image reproduction processor 171 determines whether it is instructed to end the reproduction of the moving image or the reproduction of the moving image is ended. When it is determined in step S226 that it is not instructed to end the reproduction of the moving image and the reproduction of the moving image is not ended, the procedure is returned to step S222. That is, until it is instructed to end the reproduction of the moving image or the reproduction of the moving image is ended, the processes of steps S222 to S226 are repeatedly performed. When it is determined in step S226 that it is instructed to end the reproduction of the moving image or the reproduction of the moving image is ended, the moving image reproduction processor 171 displays the image message 321 using the final frame of the moving image data and ends the procedure in step S227.

By the above-mentioned processes, it is possible to reproduce, pause, or stop the image message including moving image data. In the upper stage of FIG. 21, the message board 301-51 in which the image messages 321-71 to 321-74 until the reproduction is instructed are displayed in the state where the image messages are operated with the pointers 531-51 to 531-54 are shown. In the lower stage of FIG. 21, the message board 301-51 in which the image messages 321-71 to 321-74 under reproduction are displayed is shown. In this way, plural image messages may be reproduced at the same time. Although the final frame is used for the image message 321 after the end of reproduction, other frames may be used.

The procedure will be described with reference to FIG. 3 again.

When it is determined in step S10 that the reproduction is not instructed, the process of step S11 is skipped.

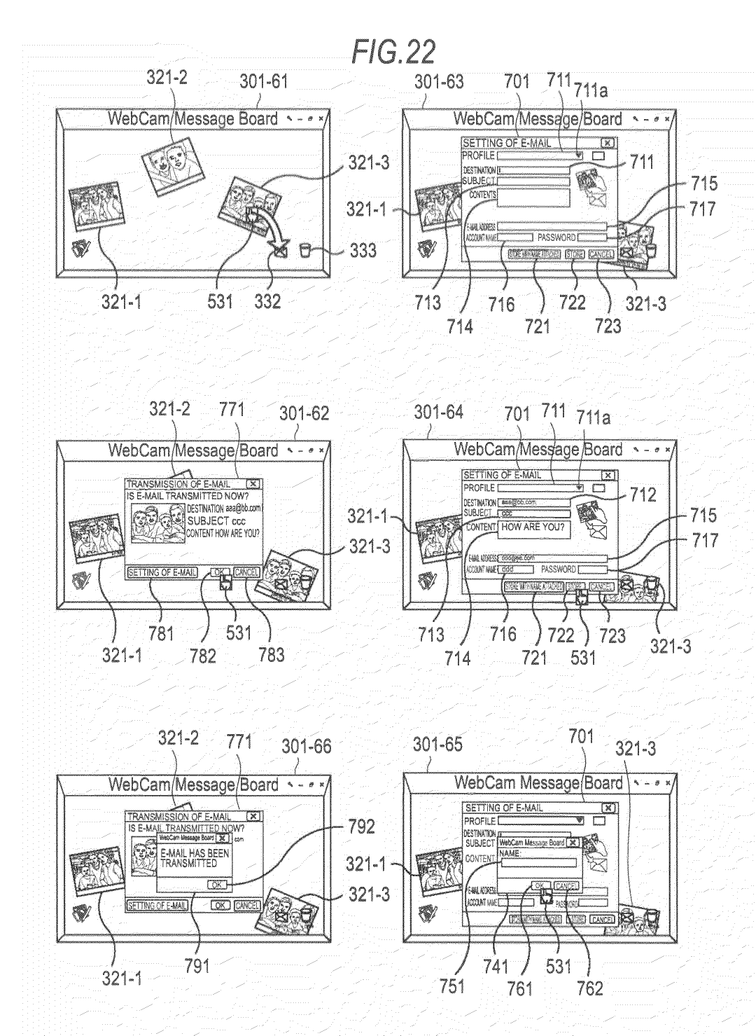

In step S12, the message selection recognizer 192 of the mail transmission manager 116 determines whether an image message is dragged and dropped at the position of the icon 332 and it is instructed to transmit an e-mail with the image message attached thereto by the use of the operation detail recognizer 113. For example, as indicated by an arrow in the message board 301-61 in FIG. 22, when the image message 321-3 is dragged and dropped at the position of the icon 332 with the pointer 531, it is considered that it is instructed to transmit an e-mail and the procedure goes to step S13.

In step S13, the mail transmission manager 116 performs a message transmitting procedure and transmits an e-mail with the dropped image message attached thereto.

### [Message Transmitting Procedure]

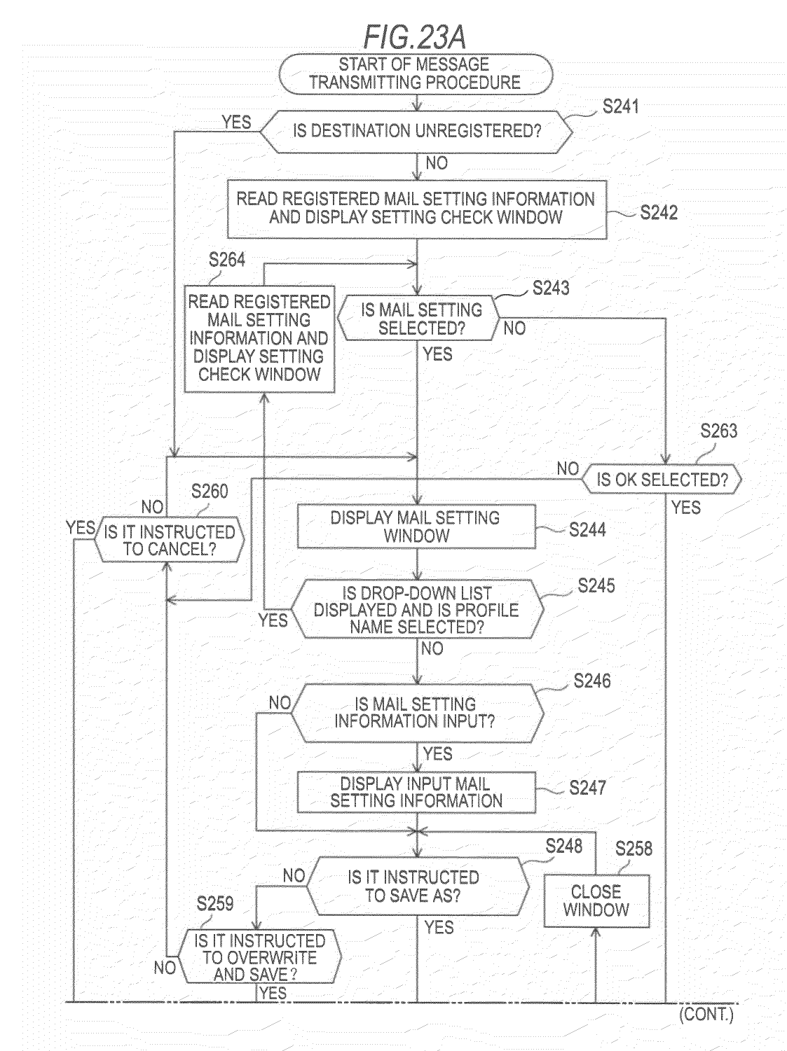

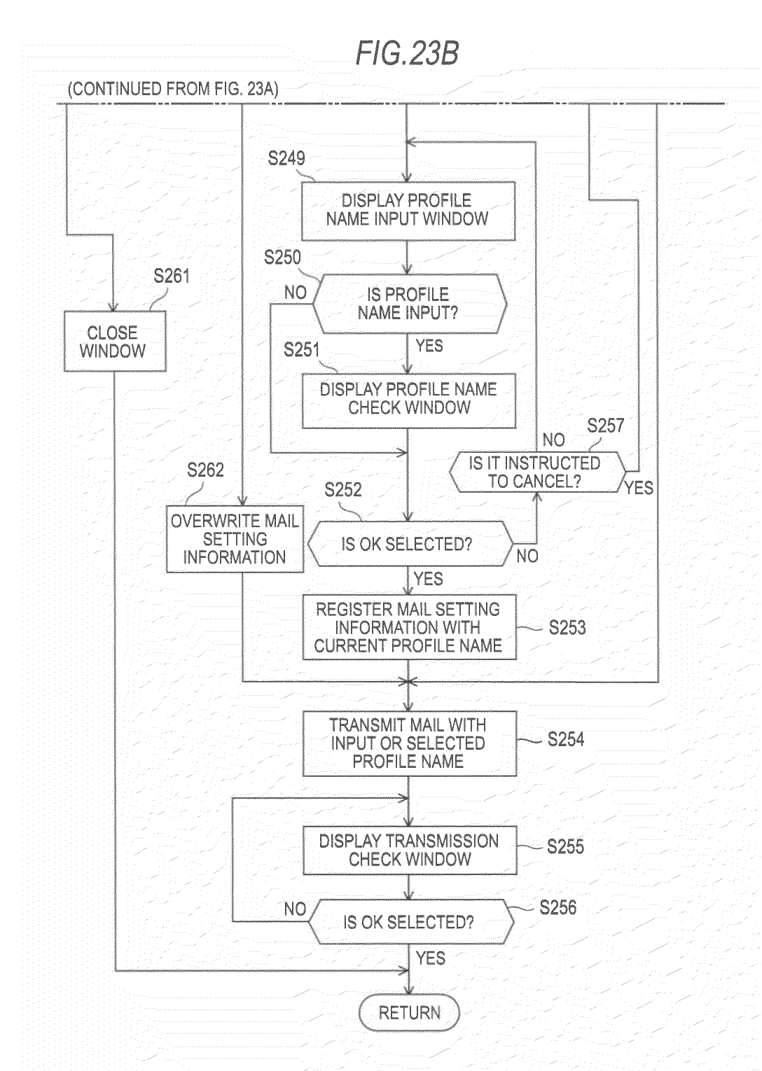

The message transmitting procedure will be described below with reference to the flow diagram of FIGS. 23A and 23B.

In step S241, the mail setting information register 191 of the mail transmission manager 116 reads the mail setting information from the storage unit 22 and determines whether a destination address is unregistered.

For example, when it is determined in step S241 that the destination address is unregistered, the procedure goes to step S244.

In step S244, the mail setting information register 191 displays a setting window 701, for example, as shown in the message board 301-63 of FIG. 22. In the setting window 701 shown in FIG. 22, a profile name line 711, a destination address line 712, a subject line 713, a content line 714, an address line 715, an account line 716, and a password line 717 are disposed from the upside. A button 721 that is operated to store the setting information as mail setting information with the profile name attached thereto, a button 722 that is pressed to save the setting information, and a button 723 that is operated to cancel the registration of the mail setting information are disposed below.

The profile name line 711 is a line in which the profile name of the mail setting information is displayed. When a triangular button 711a on the right side is pressed, plural registered profile names are displayed as a drop-down list and can be selected with a pointer. When a profile name is selected, the mail setting information registered to correspond thereto is read and the information of the destination address line 712 to the password line 717 is changed. The profile name is input at the time of new registration and is used to identify the mail setting information.

The destination address line 712 is a line in which an address specifying the destination of the e-mail is written. The subject of the e-mail to be transmitted is input to the subject line 713. The text of the e-mail to be transmitted is input to the content line 714. The e-mail address of the user of the image processing apparatus 1 as a transmission source is input to the address line 715. The account of the Internet service provider from which the user of the image processing apparatus 1 as the transmission source is provided with a service is input to the account line 716. The password corresponding to the account is input to the password line 717. When all the mail setting information is unregistered, the profile name line 711 to the password line 717 are displayed empty, as shown in the message board 301-63 of FIG. 22. When mail setting information is registered, the details of the mail setting information registered to correspond to the recently-set profile name are displayed in the profile name line 711 to the password line 717.

In step S245, the mail editing processor 193 determines whether the operation input unit 18 of the touch panel 102 is operated, the button 711a is pressed to display a drop-down list, and a profile name is selected by the use of the operation detail recognizer 113. When it is determined in step S245 that the button 711a is not pressed and any profile name is not selected, the procedure goes to step S246.

In step S246, the mail editing processor 193 determines whether the operation input unit 18 of the touch panel 102 is operated and the mail setting information is input to the destination address line 712 to the password line 717 by the use of the operation detail recognizer 113. For example, when it is determined in step S246 that the mail setting information is input to the destination address line 712 to the password line 717, the procedure goes to step S247.

In step S247, the mail editing processor 193 displays the input mail setting information in the display unit 21 of the touch panel 102, for example, as shown in the message board 301-64 of FIG. 22. In the message board 301-64 of FIG. 22, “aaa@ee.com” is input to the destination address line 712, “ccc” is input to the subject 713, and “How are you?” as a text of the e-mail is input to the content line 714. “ddd@ee.com” as the user's address as a transmission source is input to the address line 715, “ddd” is input to the account line 716, and “********” is displayed in the password line 717 so as for the input characters to be invisible to a third party.

When it is determined in step S246 that the mail setting information is not input, the process of step S247 is skipped.

In step S248, the mail setting information register 191 determines whether the operation input unit 18 of the touch panel 102 is operated to instruct to save the input mail setting information as another name by the use of the operation detail recognizer 113. For example, as shown in the message board 301-64 of FIG. 22, when it is determined in step S248 that the button 721 of the setting window 701 is pressed with the pointer 531, it is considered that it is instructed to “save as” and the procedure goes to step S249.

In step S249, the mail setting information register 191 controls the display unit 21 to display a profile name input window 741 as shown in the message board 301-65 of FIG. 22. A profile name input line 751 is disposed in the profile name input window 741 and a button 761 that is operated to instruct to complete the input and a button 762 that is operated to cancel the input of the profile name are disposed below.

In step S250, the mail editing processor 193 determines whether the profile name is input by causing the operation input unit 18 to serve as, for example, a software keyboard by the use of the operation detail recognizer 113. For example, when it is determined in step S250 that the profile name is input, the mail editing processor 193 controls the display unit 21 to display the input profile name in the profile name input line 751 of FIG. 22 in step S251. “AAA” is displayed in the profile name input line 751 in the message board 301-65 of FIG. 22, which represents that “AAA” is input as the profile name. When it is determined in step S250 that the profile name is not input, the procedure of step S251 is skipped.

In step S252, the mail setting information register 191 determines whether the operation input unit 18 is operated and the button 761 marked by “OK” is pressed to instruct to complete the input of the profile name by the use of the operation detail recognizer 113. For example, as shown in the profile name input window 741 of FIG. 22, when it is determined in step S251 that the button 761 is pressed with a pointer 531, it is considered that it is instructed to complete the input of the profile name and the procedure goes to step S253.

In step S253, the mail setting information register 191 registers the information input to the setting window 701 as the mail setting information 203 in the storage unit 22 to correspond to the profile name of the profile name input line 751 of the current profile name input window 741.

In step S254, the mail transmission processor 194 reads the mail setting information 203 stored in the storage unit 22 and reads the message data 202 corresponding to the image message 321 dropped at the position of the icon 332 in the process of step S12. The mail transmission processor 194 prepares an e-mail on the basis of the mail setting information 203 and controls the communication unit 23 to transmit the e-mail with the read message data 202 attached thereto to the destination address. At this time, the mail transmission processor 194 performs an authentication process with respect to a server of an Internet service provider on the basis of the account and the password included in the mail setting information 203 and then transmits the prepared e-mail with the image message attached thereto.

In step S255, the mail transmission processor 194 controls the display unit 21 of the touch panel 102 to display a transmission check window 791 of the e-mail, for example, as shown in the message board 301-66 of FIG. 22. “E-mail is transmitted” is displayed in the transmission check window 181 of FIG. 22, which represents that the transmission of the e-mail is completed. A button 792 marked by “OK” and operated to confirm the check is disposed in the transmission check window 791.

In step S256, the mail transmission processor 194 determines whether the operation input unit 18 is operated and the user's check on the transmission is performed (whether the button 792 marked by “OK” is pressed) by the use of the operation detail recognizer 113. When it is determined in step S256 that the user's check on the transmission is not performed, the procedure is returned to step S255. That is, until the user's check on the transmission is performed, the processes of steps S255 and S256 are repeatedly performed and the transmission check window 791 is continuously displayed.

When it is determined in step S256 that the button 792 displayed on the message board 301-66 of FIG. 22 is pressed with a pointer not shown, it is considered that the user's check on the transmission is performed and the procedure is ended.

On the other hand, when it is determined in step S252 that the button 761 marked by “OK” is not pressed, the procedure goes to step S157.

In step S257, the mail setting information register 191 determines whether the operation input unit 18 is operated and the button 762 is pressed to instruct to cancel the registration of the setting information by the use of the operation detail recognizer 113. When it is determined in step S257 that the button 762 is not pressed and it is not instructed to cancel the registration, the procedure is returned to step S249. That is, the processes of steps S249 to S252 and step S257 are repeated and the profile name input window 741 is continuously displayed.

When it is determined in step S257 that the button 762 is pressed to instruct to cancel the registration, the mail setting information register 191 closes the display of the profile name input window 741 in step S258 and the procedure is returned to step S247. That is, when the button 762 is pressed, it is considered that the registration of the profile name is cancelled and the procedure is returned to the state before it is instructed to save the setting information as the profile name.

When it is determined in step S248 that it is not instructed to save the setting information as the profile name, the procedure goes to step S259. In step S259, the mail setting information register 191 determines whether the operation input unit 18 is operated and the button 722 is pressed to instruct to overwrite and save the mail setting information by the use of the operation detail recognizer 113. When it is determined in step S259 that the button 722 is operated to instruct to overwrite and save the mail setting information, the procedure goes to step S262.

In step S262, the mail setting information register 191 overwrites and saves the information input to the setting window 701 as the mail setting information 203 in the storage unit 22 to correspond to the registered profile name and the procedure then goes to step s254. Since the overwriting save cannot be performed to correspond to a non-registered profile name, it is set that the instruction to overwrite and save the new mail setting information is disabled.

On the other hand, when it is determined in step S259 that the button 722 is not operated and it is not instructed to overwrite and save the setting information, the procedure goes to step S260. In step S260, the mail setting information register 191 determines whether the operation input unit 18 is operated and the button 723 is pressed to instruct to cancel the process of transmitting the e-mail with the image message attached thereto by the use of the operation detail recognizer 113. When it is determined in step S260 that the button 723 is pressed to instruct to cancel the process, the mail setting information register 191 closes the display of the setting window 701 and ends the message transmitting procedure in step S261. That is, since the mail setting information is not registered, the mail is not transmitted and thus the message transmitting procedure is ended.

When it is determined in step S260 that the button 723 is not pressed and it is not instructed to cancel the process, the procedure is returned to step S244. That is, the setting window 701 is continuously displayed to receive the input of the mail setting information.

Once the above-mentioned processes are performed, the mail setting information 203 is registered and thus the destination is registered. Accordingly, it is determined in the process of step S241 that the destination is not unregistered and the procedure goes to step s242.

In step S242, the mail setting information register 191 reads the mail setting information 203 stored in the storage unit 22 and displays a setting check window 771 on the basis of the mail setting information 203, as shown in the message board 301-62 of FIG. 22. Information registered in the mail setting information 203 set in the above-mentioned processes is displayed in the setting check window 771. That is, in the setting check window 771, “aaa@ee.com” is displayed as the destination address, “ccc” is displayed as the subject, and “How are you?” is displayed as contents which is the text of the e-mail. By displaying the setting check window 771 in this way, the user can confirm the details registered in the mail setting information.

A button 781 that is pressed to reset the mail setting information and that is marked by “setting of e-mail” is disposed in the lower part of the setting check window 771. A button 782 that is pressed to instruct to transmit the e-mail and that is marked by “OK” is disposed on the right side of the button 781. A button 783 that is pressed to cancel the transmission of a message and that is marked by “cancel” is disposed on the right side thereof.

In step S243, the mail setting information register 191 determines whether the operation input unit 18 is operated and the button 781 is pressed to instruct to reset the mail setting information by the use of the operation detail recognizer 113. When it is determined in step S243 that the button 781 is pressed with a pointer not shown, it is considered that it is instructed to reset the mail setting information and the procedure goes to step S244.

On the other hand, when it is determined in step S243 that the button 781 is not pressed and it is not instructed to reset the mail setting information, the procedure goes to step S263.

In step S263, the mail transmission processor 194 determines whether the button 782 marked by “OK” is pressed to instruct to transmit the e-mail by the use of the operation detail recognizer 113. When it is determined in step S263 that the button 782 is pressed to instruct to transmit the e-mail, the procedure goes to step S254. That is, the e-mail with the selected image message attached thereto is transmitted on the basis of the details registered in the current mail setting information 203.

On the other hand, when it is determined in step S263 that the button 782 is not pressed, that is, it is not instructed to transmit the e-mail, the procedure goes to step S260.

When it is determined in step S245 that the button 711a is pressed to display a drop-down list, a profile name is selected, and the button 722 is pressed to instruct to overwrite and save the setting information, the procedure goes to step S264.

In step S264, the mail setting information register 191 reads the mail setting information 203 registered to correspond to the selected profile name among the mail setting information 203 of the storage unit 22, and changes the information of the setting check window 771 to the read information. Then, the procedure is returned to step S243.

The above-mentioned processes will be arranged as follows. For example, as shown in the message board 301-61 of FIG. 22, when the image message 321-3 is dropped at the position of the icon 332 and the mail setting information is unregistered, it is prompted to register the mail setting information through the use of the setting window 701 as shown in the message board 301-63. As shown in the message board 301-64 of FIG. 22, when the destination address line 712 to the password line 717 in the setting window 701 are filled and the button 721 is pressed, the profile name input window 741 is displayed as shown in the message board 301-65.

When a profile name is input to the profile name input line 751 of the profile name input window 741 of the message board 301-65, new mail setting information is registered in the storage unit 22 to correspond to the input profile name. At this time, the message data registered to correspond to the image message 321-3 is read and is attached to the e-mail generated on the basis of the new mail setting information, and the resultant e-mail is transmitted. As a result, as shown in the message board 301-66, the transmission check window 791 is displayed.

In this way, when the mail setting information is unregistered, the display state of the message board 301-61 of FIG. 22 is sequentially changed to the display states of the message boards 301-63 to 301-66 and then the procedure is ended.

On the other hand, when the mail setting information is registered and the image message 321-3 is dropped at the position of the icon 332, for example, as shown in the message board 301-61 of FIG. 22, the setting check window 771 is displayed as in the message board 301-62. By this process, the current details of the mail setting information are presented to the user. When the e-mail can be transmitted on the basis of the mail setting information, the button 782 is pressed, the message data 202 registered to correspond to the image message 321-3 is read and is attached to the e-mail generated on the basis of the mail setting information, and the resultant e-mail is transmitted. As a result, as shown in the message board 301-66, the transmission check window 791 is displayed.

That is, when the mail setting information is once registered, it is possible to transmit the e-mail with the image message attached thereto only by dragging an image message on the message board 301 and dropping the image message onto the icon 332. Accordingly, it is possible to remove the processes of inputting the destination address, the subject, and the text by the use of a keyboard. As a result, even when the user's input function of the image processing apparatus 1 is limited to the touch panel 102, it is possible to easily transmit the e-mail with an image message attached thereto.

The procedure will be described with reference to FIG. 3 again.

When it is determined in step S12 that it is not instructed to transmit an e-mail with an image message attached thereto, the message transmitting procedure of step S13 is skipped.

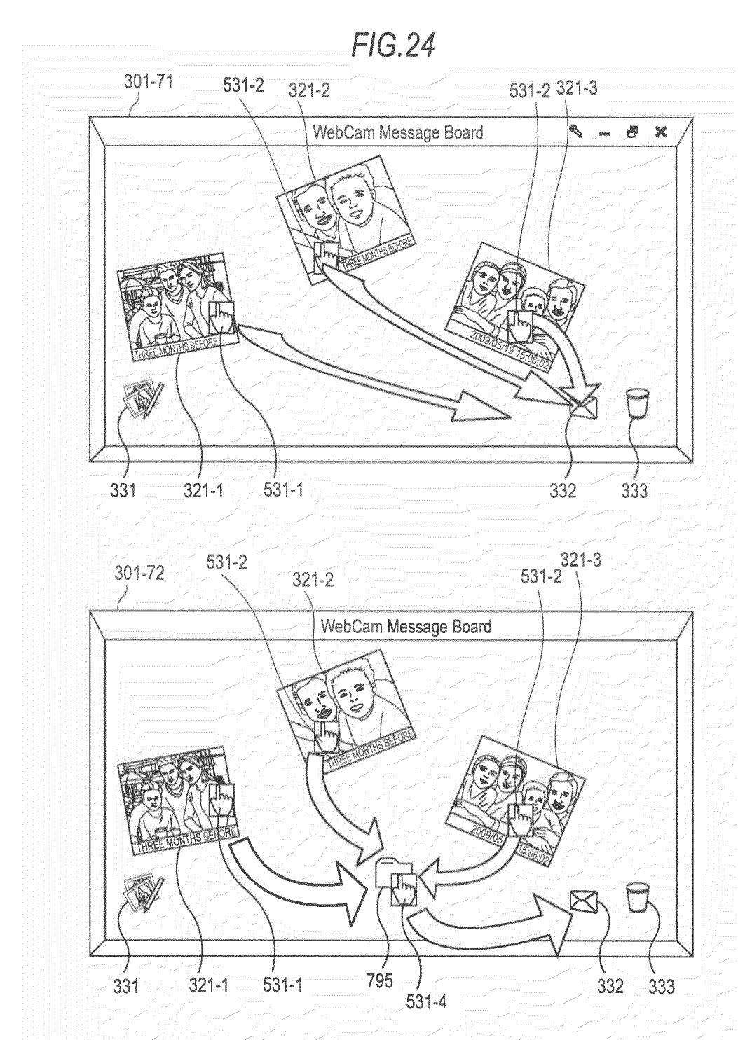

In step S12, an example where an image message 321 is dragged and dropped onto the icon 332 in response to an instruction to transmit the e-mail with the image message attached thereto is described, but the plural image messages 321 may be attached to the e-mail. That is, in the touch panel 102, as shown in the message board 301-71 of FIG. 24, plural image messages 321 may be dragged and dropped onto the icon 332 at the same time using plural fingers by a so-called multi touch technique. In the message board 301-71 of FIG. 24, plural pointers 531-1 to 531-3 are set by the multi touch on the image messages 321-1 to 321-3 and the plural image messages 321-1 to 321-3 are dragged. As indicated by arrows, the pointers 531-1 to 531-3 are moved to the position of the icon 332 and the image messages 321-1 to 321-3 are dropped at that position. In this way, by the same processes as performed when it is instructed to transmit the e-mail with the image messages 321-1 to 321-3 attached thereto and the image messages 321 are dropped, the e-mail with the image messages 321-1 to 321-3 attached thereto may be transmitted.

An electronic apparatus employing the touch panel 102 may not be provided with the multi touch function. In this case, as shown in the lower stage of FIG. 24, plural image message 321 may be dropped onto a folder and the folder may be dragged and dropped onto the icon 332. That is, in the message board 301-72 of FIG. 24, the image message 321-1 is dragged and dropped onto the folder 795, which is newly disposed to arrange plural image messages, with the pointer 531-1. Thereafter, similarly, the image message 321-2 is dragged and dropped onto the folder 795 with the pointer 531-2 and the image message 321-3 is dragged and dropped onto the folder 795 with the pointer 531-3. By this process, the image messages 321-1 to 321-3 are stored in the folder 795. Then, the folder 795 is dragged and dropped onto the icon 332 with the pointer 531-4. By this process, it may be instructed to transmit the e-mail with the image messages 321-1 to 321-3 attached thereto and the e-mail with the image messages 321-1 to 321-3 attached thereto may be transmitted by the same process as described above.

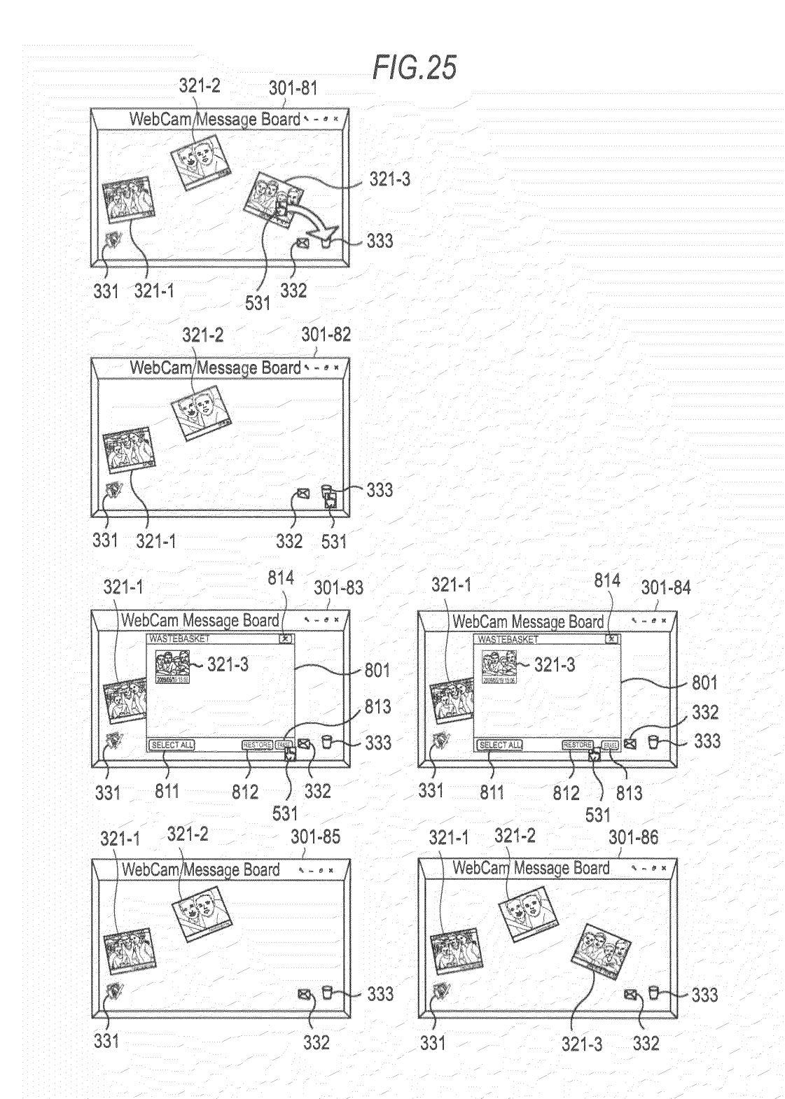

In step S14, the wastebasket manager 132 of the erasing manager 125 determines whether an image message 321 is dragged and dropped onto the icon 333 and is input to the wastebasket. For example, as shown in the message board 301-81 of FIG. 25, when it is determined in step S14 that the image message 321-3 is dragged and dropped onto the icon 333 with the pointer 531, it is considered that the image message is input to the wastebasket and the procedure goes to step S15.

In step S15, the wastebasket manager 132 registers the image message 321-3 as the wastebasket data 204 and updates the information of the message data 202 stored in the storage unit 22. Then, the wastebasket manager 132 erases the display of the image message 321-3 as shown in the message board 301-82 of FIG. 25. That is, the image message 321-3 attached to the message board 301 is changed to the display state as if it were detached and discarded to the wastebasket. However, in this case, the information of the still image or the moving image corresponding to the image message 321-3 remains in the message data 202 and the image message of the still image or the moving image is registered in the wastebasket data 204 in record. Regarding the image message to be dragged to the icon 333, plural image messages may be dropped onto the icon 333 at the same time, similarly to the message transmitting procedure.

When it is determined in step S14 that no image message 321 is dragged and dropped onto the icon 333, the process of step S15 is skipped.

In step S16, the wastebasket manager 132 determines whether the operation input unit 18 is operated and the icon 333 representing the wastebasket is pressed to instruct to manage (arrange) the image messages registered as the wastebasket data by the use of the operation detail recognizer 113. For example, as shown in the message board 301-82 of FIG. 25, when it is determined in step S16 that the pointer 531 is moved to the position of the icon 333 and the icon is pressed to instruct to manage (arrange) the wastebasket data 204, the procedure goes to step S17.

In step S17, the wastebasket manager 132 performs a wastebasket managing procedure.

### [Wastebasket Managing Procedure]

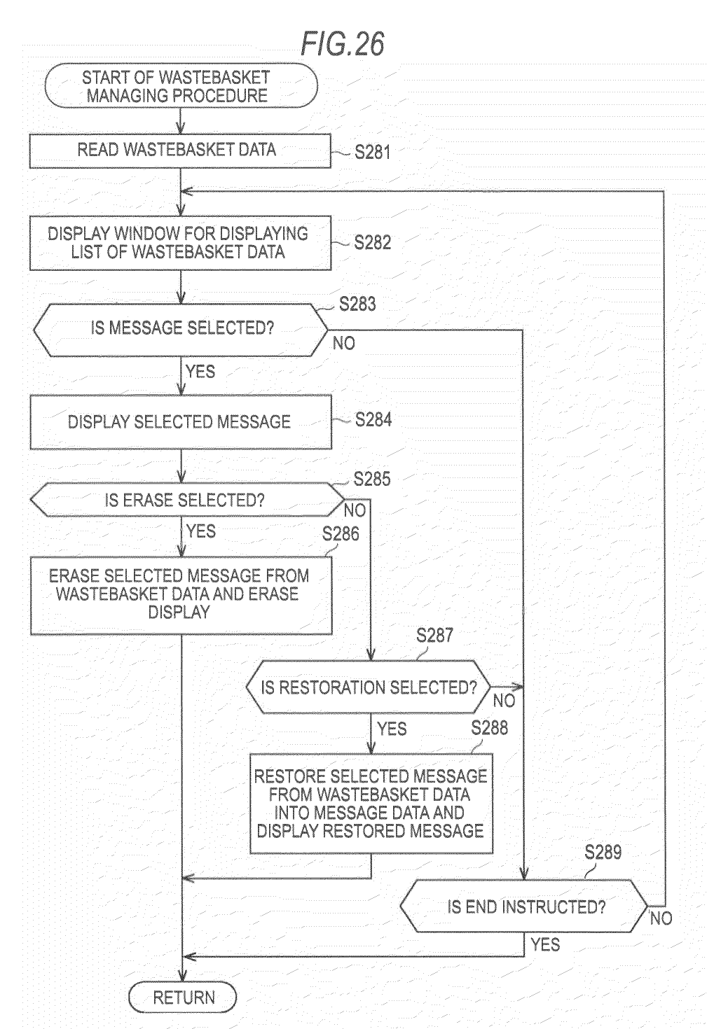

The wastebasket managing procedure will be described below with reference to the flow diagram shown in FIG. 26.

In step S281, the wastebasket manager 132 accesses the message data 202 of the storage unit 22 and reads the image messages registered in the wastebasket data 204.

In step S282, the wastebasket manager 132 displays the read image messages 321 as a list in a wastebasket window 801, as shown in the message board 301-83 of FIG. 25. The image message 321-3 registered in the wastebasket data 204 is displayed in the wastebasket window 801. A button 811 that is operated to select all the image messages 321 in the wastebasket window 801 is disposed in the wastebasket window 801. In addition, a button 812 that is operated to restore the selected image message 321 to the original message board 301 and a button 813 that is operated to completely erase the selected image message 321 are disposed therein. The buttons 812 and 813 are marked by “erase” and “restore”, respectively. A button 814 that is operated to close the window is disposed on the upper-right side of the wastebasket window 801.

In step S283, the wastebasket manager 132 determines whether any image message 321 is selected with a pointer not shown or the button 811. When it is determined in step S283 that the image message 321-3 shown in FIG. 25 is selected, the procedure goes to step S284. Here, the selected image message 321-3 is selectively displayed to represent the selected state, for example, to surround the selected image message with a thick line frame.

In step S285, the wastebasket manager 132 determines whether the operation input unit 18 is operated, the button 813 is pressed, and the erasing of the image message registered as the wastebasket data is selected by the use of the operation detail recognizer 113. For example, as shown in the message board 301-83 of FIG. 25, when it is determined in step S285 that the button 813 is pressed with the pointer 531 to select the erasing, the procedure goes to step S286.

In step S286, the wastebasket manager 132 erases and updates the data of the selected image message 321 from the wastebasket data 204 and erases the display of the wastebasket window 801 as shown in the message board 301-85 of FIG. 25. By this process, the information of the still image and the moving image corresponding to the image message 321 selected for the erasing is erased from the storage unit 22 and cannot be restored. That is, the image message 321-3 is completely erased so as not to be restored.

On the other hand, when it is determined in step S285 that the erasing of the image message registered as the wastebasket data 204 is not selected, the procedure goes to step S287. In step S287, the restoration processor 131 determines whether the restoration of the image message registered in the wastebasket data 204 is selected. For example, as shown in the message board 301-84 of FIG. 25, when it is determined in step S287 that the button 812 is pressed with the pointer 531 and the restoration of the image message registered in the wastebasket data 204 is selected, the procedure goes to step S288.

In step S288, the restoration processor 131 erases the selected image message 321 registered in the wastebasket data 204 from the wastebasket data 204 and registers the selected image message in the message data 202 again. The restoration processor 131 displays the restored image message 321-3 on the message board 301 and erases the display of the wastebasket window 801, as shown in the message board 301-86 of FIG. 25.

By this process, the image message 321 having been once erased from the message board 301 can be restored to the original state when it is wanted to restore the image message. As a result, it is possible to easily manage the image messages on the message board 301.

When it is determined in step S283 that any image message is not selected or when it is determined in step S287 that the restoration of the image message registered in the wastebasket data is not selected, the procedure goes to step S289.

In step S289, the wastebasket manager 132 determines whether the operation input unit 18 is operated and the button 814 is pressed to instruct to end the wastebasket managing procedure by the use of the operation detail recognizer 113. When it is determined in step S289 that it is not instructed to end the wastebasket managing procedure, the procedure is returned to step S282. That is, until the erasing, the restoration, or the end is instructed, the processes of steps S282 to S289 are repeated and the wastebasket window 801 is continuously displayed. When it is determined in step S289 that the button 814 is pressed to instruct the end, the wastebasket managing procedure is ended.

By the above-mentioned processes, it is possible to implement the management of the image message 321 on the main board with a feeling as if photographs were physically managed on an actual board. When an image message is once registered in the wastebasket data but is not completely erased, the image message can be restored and utilized. Accordingly, an image message carelessly having been erased but being necessary later can be restored and utilized. The example where an image message 321 is selected and erased or restored is described above, but plural image message 321 may be selected and may be erased or restored at the same time.

The procedure will be described with reference to FIG. 3 again.

When it is determined in step S16 that the wastebasket managing procedure is not instructed, the process of step S17 is skipped.

In step S18, the message display manager 114 determines whether the operation input unit 18 is operated to instruct to end the message managing procedure by the use of the operation detail recognizer 113. When it is determined in step S18 that the button 314 shown in FIG. 4 is pressed to instruct the end with a pointer not shown, the message managing procedure is ended. On the other hand, when it is determined in step S18 that it is not instructed to end the message managing procedure, the procedure is returned to step S3 and the subsequent processes thereof are repeated.

By the above-mentioned processes, in an electronic apparatus having only the input function of a touch panel, it is possible to easily prepare an image message from a still image or a moving image captured in real time. In the electronic apparatus having only the input function of a touch panel, it is possible to easily transmit an e-mail with an image message attached thereto. In an electronic apparatus employing a touch panel in which it is difficult to perform a key input operation, it is possible to easily and rapidly transmit an e-mail with an image, which includes a still image or a moving image captured in real time, attached thereto by using theses functions.

Along with surrounding persons, the user can enjoy the operation on the touch panel 102 and can easily edit and generate an image message, while viewing an image of the user or the surrounding persons in real time. Since the generated image messages are sequentially posted on the message board 301, it is possible to view and enjoy the posted image messages. It is possible to manage the image messages on the message board 301 displayed on the touch panel 102 as if photographs attached to an actual board were managed. By dragging and dropping a favorite image message to a position where the button instructing to transmit an e-mail is displayed on the touch panel 102 with a feeling of utilizing an actual board, it is possible to easily transmit an e-mail. By causing plural persons to use a single message board 301 in common, for example, by causing family members to use a single message board in common, the family members can communicate with each other while viewing individually-prepared image messages on the message board 301.

The above-mentioned series of processes may be carried out by hardware or by software. When the series of processes are performed by software, a program constituting the software is installed in a computer. Here, an example of the computer is a computer mounted on dedicated hardware or a general-purpose personal computer capable of implementing various functions by installing various programs therein.

That is, the image processing apparatus 1 shown in FIG. 1 may employ a general-purpose personal computer.

The personal computer having the above-mentioned configuration performs the above-mentioned series of processes, for example, by causing the CPU 11 to load a program stored in the storage unit 22 into the RAM 13 via the input and output interface 15 and the bus 14 and to execute the loaded program.

The program executed by the computer (the CPU 11) can be provided in a state where it is stored in the removable medium 25 such as a package medium. The program may be provided via a wired or wireless transmission medium such as a local area network, the Internet, and a digital satellite broadcast.

In the computer, the program can be installed in the storage unit 22 via the input and output interface 15 by inserting the removable medium 25 into the drive 24. The program can be received by the communication unit 23 via the wired or wireless transmission medium and can be installed in the storage unit 22. Otherwise, the program may be installed in advance in the ROM 12 or the storage unit 22.

In the embodiment of the present technology, the process steps describing the program stored in a recording medium include processes time-series performed in the described order and processes in parallel or independently without necessarily being performed in time series.

The present application contains subject matter related to that disclosed in Japanese Priority Patent Application JP 2010-110419 filed in the Japan Patent Office on May 12, 2010, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus having a display unit, comprising:
an operation section configured to generate an operation signal based on a user's contact with the display unit;
a posting area display control section configured to display a posting area in which an image is posted on the display unit and displaying previously-generated images in the posting area;
an operation detail recognizing section configured to recognize an operation detail on the images posted in the posting area on the basis of the operation signal from the operation section; and
a selection section configured to select an image corresponding to the operation detail recognized by the operation detail recognizing section as an operation object.

2. The image processing apparatus according to claim 1, wherein the operation detail recognizing section recognizes that the operation detail is an operation of coming into contact with a broad area including a certain image among the images when a contact area in which the user comes into contact with the display unit and which includes the certain image among the images posted in the posting area is broader than a predetermined area in the posting area on the basis of the operation signal from the operation section, and
wherein the selection section selects the image existing in a coverage defined by the contact area in the posting area recognized by the operation detail recognizing section as the operation object.

3. The image processing apparatus according to claim 1, wherein the selection section selects the images existing in a coverage within a radius corresponding to a parameter indicating the operation detail, which is recognized by the operation detail recognizing section, with the image as the center which the user comes into contact with as the operation object.

4. The image processing apparatus according to claim 3, further comprising a holding time measuring section configured to measure a holding time in which the user's contact with the predetermined image posted in the posting area is held on the basis of the operation signal from the operation section,
wherein the parameter indicating the operation detail is the holding time in which the user's contact with the image posted in the posting area is held and which is measured by the holding time measuring section,
wherein the operation detail recognizing section recognizes that the operation detail is an operation of holding the contact with the image when the holding time measured by the holding time measuring section is longer than a predetermined time, and
wherein the selection section selects the image existing in the coverage within a radius corresponding to the holding time with the image as the center on which the operation, which is recognized by the operation detail recognizing section, of holding the contact with the image is performed as the operation object.

5. The image processing apparatus according to claim 3, further comprising:
a pressure measuring section configured to measure a pressure of the user's contact with an image posted in the posting area on the basis of the operation signal from the operation section; and
a hierarchical level managing section configured to manage hierarchical levels of the images in the posting area in the depth direction,
wherein the parameter indicating the operation detail is the pressure, which is measured by the pressure measuring section, of the user's contact with a predetermined image posted in the posting area,
wherein the operation detail recognizing section recognizes that the operation detail is an operation of coming into contact with the image with a high pressure when the pressure, which is measured by the pressure measuring section, of the user's contact with the image posted in the posting area is greater than a predetermined pressure, and
wherein the selection section selects the images existing in the coverage within a radius corresponding to the pressure with the image as the center on which the operation, which is recognized by the operation detail recognizing section, of coming contact with the image with a high pressure is performed as the operation object.

6. The image processing apparatus according to claim 3, wherein the posting area display control section collectively displays the images existing in the coverage within a radius corresponding to the parameter indicating the operation detail recognized by the operation detail recognizing section with the image as the center and selected as the operation object by the selection section at the position of the image as the center.

7. The image processing apparatus according to claim 1, wherein the selection section selects the images existing within a hierarchical level corresponding to the parameter indicating the operation detail recognized by the operation detail recognizing section from the hierarchical level of the image which the user comes into contact with as the operation object.

8. The image processing apparatus according to claim 7, further comprising:
a holding time measuring section configured to measure a holding time in which the user's contact with a predetermined image posted in the posting area is held on the basis of the operation signal from the operation section; and
a hierarchical level managing section configured to manage hierarchical levels of the images in the posting area in the depth direction,
wherein the parameter indicating the operation detail is the holding time, which is measured by the holding time measuring section, of the user's contact with a predetermined image posted in the posting area,
wherein the operation detail recognizing section recognizes that the operation detail is an operation of holding the contact with a predetermined image when the holding time measured by the holding time measuring section is longer than a predetermined time, and
wherein the selection section selects the images existing from the hierarchical level, which is the highest hierarchial level, of the image on which the operation of holding the contact with the predetermined image is performed to the hierarchical level set to correspond to the holding time among the images contacting the predetermined image on which the operation of holding the contact with the predetermined image is performed as the operation object on the basis of the image on which the operation, which is recognized by the operation detail recognizing section, of holding the contact with the predetermined image is performed and the hierarchical levels, which are managed by the hierarchical level managing section, of the images contacting the predetermined image.

9. The image processing apparatus according to claim 7, further comprising:
a pressure measuring section configured to measure a pressure of the user's contact with an image posted in the posting area on the basis of the operation signal from the operation section; and
a hierarchical level managing section configured to manage hierarchical levels of the images in the posting area in the depth direction,
wherein the parameter indicating the operation detail is the pressure, which is measured by the pressure measuring section, of the user's contact with a predetermined image posted in the posting area,
wherein the operation detail recognizing section recognizes that the operation detail is an operation of coming into contact with the predetermined image with a high pressure when the pressure, which is measured by the pressure measuring section, of the user's contact with the predetermined image posted in the posting area is greater than a predetermined pressure, and
wherein the selection section selects the images existing from the hierarchical level, which is the highest hierarchial level, of the image on which the operation of coming into contact with the predetermined image with a high pressure is performed to the hierarchical level set to correspond to the pressure among the images contacting the image on which the operation of coming into contact with the predetermined image with a high pressure is performed as the operation object on the basis of the predetermined image on which the operation, which is recognized by the operation detail recognizing section, of coming into contact with the predetermined image with a high pressure is performed and the hierarchical levels, which are managed by the hierarchical level managing section, of the images contacting the predetermined image.

10. The image processing apparatus according to claim 7, wherein the posting area display control section collectively displays the images existing within the hierarchical level corresponding to the parameter indicating the operation detail recognized by the operation detail recognizing section and selected as the operation object by the selection section at the position of the image as the center.

11. The image processing apparatus according to claim 1, wherein the operation detail recognizing section recognizes that the operation detail is an operation of coming into contact with an area not including any image when the contact area is an area not including any image in the posting area on the basis of the operation signal from the operation section,
wherein the selection section selects all the images as the operation object on the basis of the operation detail recognized by the operation detail recognizing section, and
wherein the posting area display control section arranges and displays all the images posted in the posting area.

12. The image processing apparatus according to claim 11, wherein the posting area display control section acquires current positions of all the selected images and destination positions after the arrangement and displays all the images posted in the posting area at positions moved only by a predetermined distance among distances from the current positions to the destination positions.

13. An image processing method in an image processing apparatus having a display unit, an operation section configured to generate an operation signal based on a user's contact with the display unit, a posting area display control section configured to display a posting area in which an image is posted on the display unit and displaying previously-generated images in the posting area, an operation detail recognizing section configured to recognize an operation detail on the images posted in the posting area on the basis of the operation signal from the operation section, and a selection section configured to select an image corresponding to the operation detail recognized by the operation detail recognizing section as an operation object, the image processing method comprising the steps of:
causing the operation section to generate the operation signal based on the user's contact with the display unit;
causing the posting area display control section to display the posting area in which an image is posted on the display unit and to display the previously-generated images in the posting area;
causing the operation detail recognizing section to recognize the operation detail on the images posted in the posting area on the basis of the operation signal generated in the step of generating the operation signal; and
causing the selection section to select an image corresponding to the operation detail recognized in the step of recognizing the operation detail as the operation object.

14. A program allowing a computer to control an image processing apparatus having a display unit, an operation section configured to generate an operation signal based on a user's contact with the display unit, a posting area display control section configured to display a posting area in which an image is posted on the display unit and displaying previously-generated images in the posting area, an operation detail recognizing section configured to recognize an operation detail on the images posted in the posting area on the basis of the operation signal from the operation section, and a selection section configured to select an image corresponding to the operation detail recognized by the operation detail recognizing section as an operation object, the program causing the computer to perform an image processing method comprising the steps of:
causing the operation section to generate the operation signal based on the user's contact with the display unit;
causing the posting area display control section to display the posting area in which an image is posted on the display unit and to display the previously-generated images in the posting area;
causing the operation detail recognizing section to recognize the operation detail on the images posted in the posting area on the basis of the operation signal generated in the step of generating the operation signal; and
causing the selection section to select an image corresponding to the operation detail recognized in the step of recognizing the operation detail as the operation object.

15. An image processing apparatus having a display unit, comprising:
an operation unit configured to generate an operation signal based on a user's contact with the display unit;
a posting area display control unit configured to display a posting area in which an image is posted on the display unit and displaying previously-generated images in the posting area;
an operation detail recognizing unit configured to recognize an operation detail on the images posted in the posting area on the basis of the operation signal from the operation unit; and
a selection unit configured to select an image corresponding to the operation detail recognized by the operation detail recognizing section as an operation object.
